(19) United States
(12) Patent Application Publication
(10) Pub. No.: US 2025/0357493 A1
(43) Pub. Date: Nov. 20, 2025

(54) STACK, ELECTRODE STRUCTURE, BATTERY, AND FLIGHT VEHICLE

(71) Applicant: SoftBank Corp., Tokyo (JP)

(72) Inventors: Shuntaro MIYAKAWA, Tokyo (JP); Takaya SAITO, Tokyo (JP); Taisei SAKATA, Tokyo (JP); Yoshiki TAKAYANAGI, Tokyo (JP)

(21) Appl. No.: 19/280,105

(22) Filed: Jul. 25, 2025

Related U.S. Application Data
(63) Continuation of application No. PCT/JP2024/009441, filed on Mar. 11, 2024.

(30) Foreign Application Priority Data
Apr. 7, 2023 (JP) 2023-063059

(51) Int. Cl. H01M 4/66; H01M 4/62; H01M 10/04

(52) U.S. Cl. CPC H01M 4/667; H01M 4/622; H01M 4/661; H01M 10/0413; H01M 2220/20

(57) ABSTRACT

A stack including a plurality of sheet materials that are stacked is provided. In the above-described stack, each of a plurality of sheet materials has a support layer including thermoplastic resin material, and a first metal layer and a second metal layer formed on both faces of the support layer. In a part of the plurality of sheet materials, a plurality of first metal layers and a plurality of second metal layers included in the plurality of sheet materials are integrated and each of the plurality of first metal layers and the plurality of second metal layers includes a concave and convex region where each metal layer has a bellows-like shape or a wrinkled shape.

The contents of the following patent application(s) are incorporated herein by reference:
NO. 2023-063059 filed in JP on Apr. 7, 2023
NO. PCT/JP2024/009441 filed in WO on Mar. 11, 2024.

### BACKGROUND

### 1. Technical Field

The present invention relates to a stack, an electrode structure, a battery, and a flight vehicle.

### 2. Related Art

Patent Documents 1 to 2 disclose a welding method for a material including a resin and a metal. Patent Document 3 discloses a current collector having an electrically conductive material arranged in a through-hole.

### CONVENTIONAL ART DOCUMENT

### Patent Document

Patent Document 1: Japanese Patent Application Publication No. 2004-130331
Patent document 2: Japanese Patent Application Publication No. 2006-305591
Patent document 3: Japanese Patent Application Publication No. 2019-186204

### BRIEF DESCRIPTION OF THE DRAWINGS

FIG. 1 schematically illustrates one example of a system configuration of a flight vehicle 100.

FIG. 2 schematically illustrates one example of a power storage cell 112.

FIG. 3 schematically illustrates another example of the power storage cell 112.

FIG. 4 schematically illustrates one example of a current collector 400.

FIG. 5 schematically illustrates one example of a current collector 500.

FIG. 6 schematically illustrates one example of a current collector 600.

FIG. 7 schematically illustrates one example of a stack structure 760.

FIG. 8 schematically illustrates one example of an electrical connection relationship between the electrodes of the stack structure 760.

FIG. 9 schematically illustrates one example of a producing method of the power storage cell 112.

FIG. 10 schematically illustrates one example of a producing method of a positive electrode 220.

FIG. 11 illustrates one example of a welding procedure using a welding device 1120.

FIG. 12 illustrates one example of a plurality of through-holes 620 arranged in a current collector 1102.

FIG. 13 illustrates one example of the plurality of through-holes 620 arranged in the current collector 1102.

FIG. 14 illustrates one example of a procedure for fabricating the stack structure 760.

FIG. 15 schematically illustrates one example of the top view of a positive electrode connection 820.

FIG. 16 schematically illustrates one example of the cross-section of the positive electrode connection 820.

FIG. 17 schematically illustrates one example of the cross-section of the positive electrode connection 820.

FIG. 18 schematically illustrates one example of the positive electrode current collector 222 including a concave and convex region 1600.

FIG. 19 schematically illustrates one example of a concave and convex region 1900.

FIG. 20 schematically illustrates another example of the cross-section of the positive electrode connection 820.

FIG. 21 schematically illustrates yet another example of the cross-section of the positive electrode connection 820.

FIG. 22 illustrates one example of the X-ray CT observation result for the weld point and the surroundings in Implementation Example 1.

FIG. 23 illustrates one example of the X-ray CT observation result for the observation region 2200.

FIG. 24 illustrates one example of the X-ray CT observation result for the observation region 2300.

FIG. 25 illustrates one example of the SEM image of the cross-section of the weld point and the surroundings in comparative example 1.

### DESCRIPTION OF EXEMPLARY EMBODIMENTS

According to one embodiment exemplified in the present specification (sometimes referred to as the present embodiment), the stack is fabricated by welding a part of a plurality of welding targets stacked together. Each of the above-described plurality of welding targets includes a support layer including resin material and a first metal layer and a second metal layer formed on both faces of the support layer. The above-described welding target may be sheet-shaped material (sometimes referred to as sheet material). The above-described welding target may be a current collector used for an electrode of a battery.

The first metal layer and the second metal layer of each of the above-described plurality of welding targets are electrically connected. In this way, the first metal layer and the second metal layer may be welded via resistance welding, for example.

The type of the above-described resin material is not particularly limited but any thermoplastic resin material may be used as the resin material. The support layer may be substantially constituted of thermoplastic resin material and the support layer may be the thermoplastic resin material.

By using the thermoplastic resin material as a main component of the support layer, for example, the safety of the battery improves when the stack is used as an electrode of a battery. More specifically, when the above-described battery has a thermal runaway, the thermoplastic resin material melts due to the heat. As a result, the thermal runaway may stop.

In addition, thermoplastic resin material softens and increases its fluidity when the temperature of the resin material rises. In this way, in the welding process of a plurality of welding targets, when pressure is applied to the heated welding targets, the resin material arranged between the first metal layer and the second metal layer easily moves and the first metal layer and the second metal layer come close to or come into contact with each other. In this state, when energy is applied to the first metal layer and the second metal layer, the first metal layer and the second metal layer are integrated.

According to one example of the present embodiment, a plurality of welding targets are welded by the procedure described below. At first, energy is applied to the softened region arranged in a part of the plurality of welding targets. As described above, the support layer of the welding target in the present embodiment mainly includes, for example, thermoplastic resin material. When appropriate energy is applied to the softened region of the welding target, the temperature of the thermoplastic resin material included in the support layer rises and the resin material softens.

Then, a weld region arranged in at least a part of the softened region of the welding target is pressed. In this way, pressure is applied to the resin material of the support layer arranged between the first metal layer and the second metal layer. The resin material existing inside the weld region softens and has a moderate fluidity. Therefore, when an appropriate magnitude of pressure is applied to the resin material of the support layer, the resin material moves inside the welding target.

When welding the first metal layer and the second metal layer, applying pressure to the first metal layer and the second metal layer so that the first metal layer and the second metal layer come close to or contact to each other causes the resin material arranged between the first metal layer and the second metal layer to be extruded to the surroundings of the weld point. The present inventor found that, depending on the thickness of the first metal layer and the second metal layer, the volume of the resin material extruded to the surroundings of the weld point, the viscosity or mobility of the resin material, or the like, when the resin material arranged at the weld point is extruded to the surroundings of the weld point, the first metal layer and the second metal layer arranged at the surroundings of the weld point may be fractured by the resin material.

In addition, the present inventor found that when the above-described metal layer is fractured, the variance in the measurement values of the electrical resistance among a plurality of sheet materials that are integrated is greater than a predetermined threshold. For example, it is assumed that parts of the sheet material A, the sheet material B, and the sheet material C are integrated through welding. As described above, each sheet material includes a support layer including a resin material, and a first metal layer and a second metal layer that are formed on both faces of the support layer. The sheet material A, the sheet material B, and the sheet material C are stacked such that the second metal layer of the sheet material A and the first metal layer of the sheet material B contact to each other, and the second metal layer of the sheet material B and the first metal layer of the sheet material C contact to each other. In addition, a part of the stacked sheet material is welded according to the above-described procedure.

In this case, the first metal layer and the second metal layer included in the sheet material A, the sheet material B, and the sheet material C are integrated at the weld points and all the metal layers are electrically connected. Therefore, it was assumed that the variance in the electrical resistances among the plurality of metal layers is sufficiently small.

However, the present inventors measured (i) the electrical resistance between any point on the first metal layer of the sheet material A and any point on the second metal layer of the sheet material A or any point on the first metal layer of the sheet material B, (ii) the electrical resistance between any point on the first metal layer of the sheet material A and any point on the second metal layer of the sheet material B or any point on the first metal layer of the sheet material C, (iii) the electrical resistance between any point on the first metal layer of the sheet material A and any point on the second metal layer of the sheet material C, (iv) the electrical resistance between any point on the first metal layer of the sheet material B and any point on the second metal layer of the sheet material B or any point on the first metal layer of the sheet material C, (v) the electrical resistance between any point on the first metal layer of the sheet material B and any point of the second metal layer of the sheet material C, and (vi) the electrical resistance between any point on the first metal layer of the sheet material C and any point on the second metal layer of the sheet material C, and found that there may be variances in the measurement values. The reason is not necessarily apparent, but it is inferred that at least parts of the first metal layer and the second metal layer that are arranged at the surroundings of the weld point were fractured, and, as a result, the conductive path in the surroundings of the weld point became complex.

In addition, the present inventors found that the above-described variance is smaller when a region where the first metal layer and the second metal layer have a bellows-like shape or a wrinkled shape (sometimes referred to as a concave and convex region) is formed in the surroundings of the weld point than when half or more of the first metal layer and the second metal layer included in the stack are fractured in the vicinity of the weld point. The reason that the concave and convex region formed in the first metal layer and the second metal layer reduces the above-described variance is not necessarily apparent, but it is inferred that, when the resin material arranged at the weld point is extruded to the surroundings of the weld point, the first metal layer and the second metal layer move or deform, which prevents the fracture of the first metal layer and the second metal layer.

The above-described stack with a small variance is obtained so that the variance in the electrode reaction in each layer of the above-described stack-type battery is suppressed when, for example, the plurality of metal layers constituting the above-described stack are used as the members constituting parts of the current collector of the above-described stack-type battery. As a result, the life property of the stack-type battery improves.

In addition, the present inventors found that the above-described concave and convex region may be formed when, for example, the above-described support layer includes, as a main component, a thermoplastic resin having a lower melting point than polyimide. Examples of the main component of the support layer include a component at a content of more than 50% by mass in the support layer, a component at a content of 51% or more by mass in the support layer, or the like. Furthermore, the present inventors found that the above-described concave and convex region may be formed when one or more through-holes are formed extending through the support layer, the first metal layer, and the second metal layer in the weld point as a welding target before welding and/or its vicinity.

As described above, the above-described welding target is, for example, a current collector used for an electrode of a battery, and the method for producing the above-described stack or the method for welding the plurality of stacked welding targets may be applied to the fabrication of the electrode structure arranged inside the housing of the battery (particularly. a secondary battery). In addition, according to the present embodiment, a part of the current collector is formed of a substance having a lower density than that of an aluminum foil or copper foil (typically, air or resin material).

As a result, a power storage cell with an excellent energy density per unit mass and/or an excellent capacity per unit mass of an active material may be provided. For example, according to the present embodiment, a power storage cell with an energy density per unit mass of 350 [Wh/kg—power storage cell] or more may be provided. In addition, a battery including the power storage cell according to the present embodiment is particularly suitable for an application of a flight vehicle because it has a high energy density per unit mass.

As described above, according to the present embodiment, for example, the energy amount per weight in a rechargeable battery can be improved and a rechargeable battery that is lighter and can accumulate more electrical power can be achieved. For example, the rechargeable battery may be brought to a disaster site and used for energy supply to victims or the like.

Therefore, the stack, the electrode structure, and the battery according to the present embodiment as well as the producing method thereof can contribute to achieving goal 7 “clean energy for everyone”, goal 13 “concrete action for climate change”, or the like of the Sustainable Development Goals (SDGs).

Hereinafter, the present invention will be described through embodiments of the invention, but the following embodiments do not limit the invention according to the claims. In addition, not all of the combinations of features described in the embodiments are imperative to the solutions of the invention.

In the present specification, when a numerical range is expressed as “from A to B”, the expression means A or more and B or less. In addition, “substituted or unsubstituted” means “substituted with any substituent, or not substituted with a substituent”. A type of substituent described above is not particularly limited unless otherwise stated in the specification. In addition, the number of substituents described above is not particularly limited unless otherwise stated in the specification.

### (the Overview of the Flight Vehicle 100)

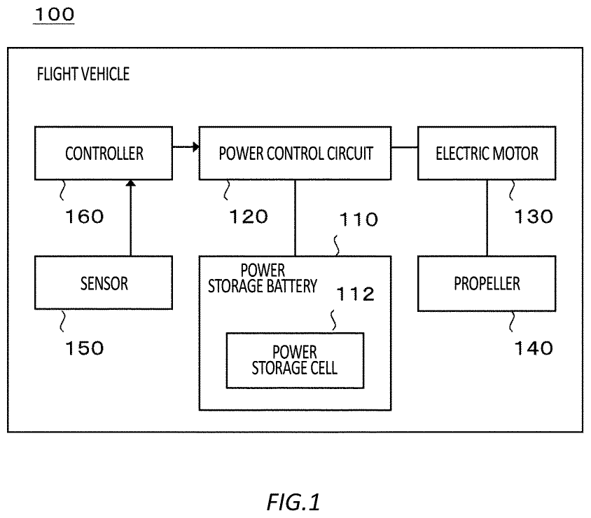

FIG. 1 schematically illustrates one example of the system configuration of the flight vehicle 100. In the present embodiment, the flight vehicle 100 includes a power storage battery 110, a power control circuit 120, one or more electric motors 130, one or more propellers 140, one or more sensors 150, and a controller 160. In the present embodiment, the power storage battery 110 has one or more power storage cells 112.

In the present embodiment, the flight vehicle 100 flies by using the electrical energy accumulated in the power storage battery 110. Examples of the flight vehicle include an airplane 100, an airship or a balloon, a hot-air balloon, a helicopter, a drone, or the like.

In the present embodiment, the power storage battery 110 receives electrical energy from an external charging device (not shown in the figure) via the power control circuit 120 and accumulates the electrical energy in the one or more power storage cells 112. In addition, the power storage battery 110 supplies the electrical energy accumulated in the one or more power storage cell 112 to the electric motor 130 via the power control circuit 120.

In the present embodiment, the power storage cell 112 accumulates electrical energy, which is sometimes referred to as the charging of the power storage cell 112. In addition, the power storage cell 112 releases the accumulated electrical energy, which is sometimes referred to as the discharging of the power storage cell 112. The power storage cell 112 may be a secondary battery.

The power storage cell 112 may be a solid-state battery. The power storage cell 112 may be a solid-state secondary battery. The solid-state secondary battery is the secondary battery that substantially does not include the above-described electrolytic solution or gel electrolyte but includes, for example, a pair of electrodes and a solid electrolyte layer arranged between the pair of electrodes.

The secondary battery substantially not including the electrolytic solution or the gel electrolyte means not only the secondary battery not including the electrolytic solution or the gel electrolyte but also the secondary battery including small amounts of the electrolytic solution or the gel electrolyte. This is because even if the constituent material of the secondary battery dissolves in the electrolytic solution or the solvent included in the gel electrolyte, the effect of the constituent material of the secondary battery dissolving in the solvent on the performance of the battery may be ignored as long as the amount of the solvent included in the secondary battery is small.

In one embodiment, the power storage cell 112 does not include at least one of (i) the electrolytic solution including supporting electrolyte salt and solvent or (ii) the gel electrolyte including supporting electrolyte salt, organic polymer compounds, and organic solvent. In another embodiment, the ratio of the mass of the electrolytic solution and the gel electrolyte [kg] to the mass of the organic compound used for active material [kg] is less than 5%.

Examples of the carrier ions of the secondary battery include lithium, sodium, potassium, magnesium, calcium, or the like. Examples of the secondary battery include a sodium ion secondary battery, a lithium ion secondary battery, a lithium metal secondary battery, a lithium air secondary battery, a lithium sulfur secondary battery, a magnesium ion secondary battery, or the like.

For example, a material that can accumulate a large charge amount per unit volume is often selected as the active material for the secondary battery to be mounted on the vehicle. On the other hand, in the present embodiment, the power storage cell 112 is mounted on the flight vehicle 100. Therefore, the active material used for the power storage cell 112 is preferably a material that can accumulate a large charge amount per unit mass.

The mass energy density of the power storage cell 112 is preferably 350 [Wh/kg-power storage cell] or more, more preferably 400 [Wh/kg-power storage cell] or more, more preferably 500 [Wh/kg-power storage cell] or more, more preferably 600 [Wh/kg-power storage cell] or more, and even more preferably 700 [Wh/kg-power storage cell] or more. In this way, the power storage cell particularly suitable for the application of the power supply for the flight vehicle is obtained.

The volume energy density of the power storage cell 112 may be 300 [Wh/m³-power storage cell] or more and 1200 [Wh/m³-power storage cell] or less or may be 400 [Wh/m³-power storage cell] or more and 1000 [Wh/m³-power storage cell] or less. If the power storage cell 112 is mounted on the flight vehicle 100 as a part of the power supply of the flight vehicle 100, the volume energy density of the power storage cell 112 may be 600 [Wh/m³-power storage cell] or less or may be 800 [Wh/m³-power storage cell] or less.

The power storage cell 112 may have a mass energy density within the above-described numerical range and a volume energy density within the above-described numerical range. In this way, the power storage cell that is relatively difficult to use for the power supply of the vehicle can be used as the power supply of the flight vehicle. The details of the power storage cell 112 will be described below.

In the present embodiment, the power control circuit 120 controls the input and output of the electrical power of the power storage battery 110. The power control circuit 120 may control the input and output of the electrical power of the power storage battery 110 based on the instruction from the controller 160. For example, the power control circuit 120 includes a plurality of switching devices that operate based on the control signal from the controller 160.

In the present embodiment, the electric motor 130 receives the electrical energy from the power storage battery 110 via the power control circuit 120. The electric motor 130 uses the electrical energy received from the power storage battery 110 to rotate the propeller 140. In this way, the electric motor 130 can generate the propulsive force of the flight vehicle 100 using the electrical energy accumulated in the power storage cell 112.

In the present embodiment, the sensor 150 measures various physical quantities related to the position and posture of the flight vehicle 100. Examples of sensors for measuring the various physical quantities related to the position and posture of the flight vehicle 100 include a GPS signal receiver, an acceleration sensor, an angular acceleration sensor, a gyro sensor, or the like. The sensor 150 may measure various physical quantities related to the state of the power storage battery 110. Examples of a sensor for measuring various physical quantities related to the state of the power storage battery 110 include a temperature sensor, a current sensor, a voltage sensor, or the like.

In the present embodiment, the controller 160 controls the flight vehicle 100. The controller 160 may control the input and output of the electrical power of the power storage battery 110 by controlling the power control circuit 120. For example, the controller 160 controls the output current, the output voltage, the input current, the input voltage, or the like of the power storage battery 110. In this way, the controller 160 can control the position and posture of the flight vehicle 100. The controller 160 may control the position and posture of the flight vehicle 100 by controlling the power control circuit 120 based on the output from the sensor 150.

The power storage battery 110 may be one example of a secondary battery. The power storage cell 112 may be one example of a secondary battery. The electric motor 130 may be one example of a propulsive force generator. The secondary battery may be one example of a battery.

### (Overview of Power Storage Cell 112)

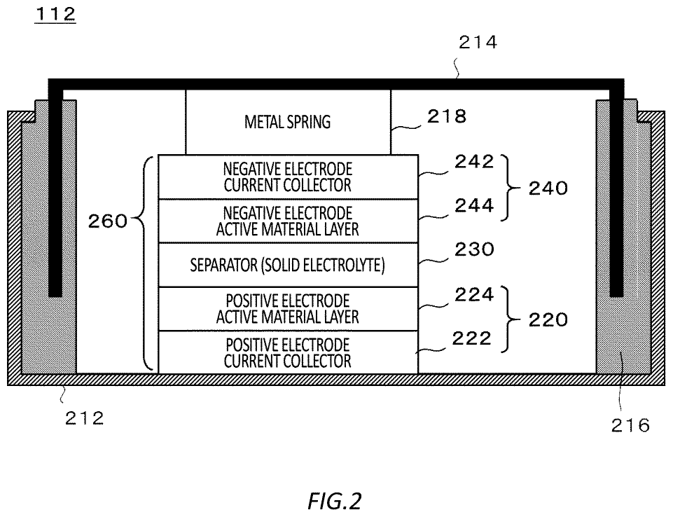

FIG. 2 schematically illustrates one example of the power storage cell 112. In the present embodiment, the detail of the power storage cell 112 is described by using an example in which the power storage cell 112 is a coin-shaped solid-state secondary battery. However, it is noted that the power storage cell 112 is not limited to the coin-shaped solid-state secondary battery.

### (Power Storage Cell)

In the present embodiment, the power storage cell 112 includes a positive electrode case 212, a negative electrode case 214, a sealant 216, and a metal spring 218. In addition, the power storage cell 112 includes a positive electrode 220, a separator 230, and a negative electrode 240. In the present embodiment, the positive electrode 220 has a positive electrode current collector 222 and a positive electrode active material layer 224. In the present embodiment, the negative electrode 240 has a negative electrode current collector 242 and a negative electrode active material layer 244.

In the present embodiment, the power storage cell 112 includes a structure 260 having a positive electrode 220, a separator 230, and a negative electrode 240. As illustrated in FIG. 2, the positive electrode 220, the separator 230, and the negative electrode 240 are stacked in this sequence and the separator 230 is arranged between the positive electrode 220 and the negative electrode 240.

In the present embodiment, the detail of the power storage cell 112 is described by using an example in which the power storage cell 112 substantially does not include the electrolytic solution or the gel electrolyte. In addition, in the present embodiment, the detail of the power storage cell 112 is described by using an example in which the positive electrode current collector 222 has (i) an electrically conductive layer including electrically conductive material and (ii) a support layer supporting the electrically conductive layer.

In the present embodiment, by assembling the positive electrode case 212 and the negative electrode case 214, spaces are formed inside the positive electrode case 212 and the negative electrode case 214. The metal spring 218, the positive electrode 220, the separator 230, and the negative electrode 240 are accommodated inside the space formed by the positive electrode case 212 and the negative electrode case 214. The positive electrode 220, the separator 230, and the negative electrode 240 are fixed, by a repulsive force of the metal spring 218, inside the positive electrode case 212 and the negative electrode case 214.

The positive electrode case 212 and the negative electrode case 214 are constituted of an electrically conductive material having, for example, a disc-like thin plate shape. In the present embodiment, the sealant 216 seals the gap formed between the positive electrode case 212 and the negative electrode case 214. The sealant 216 includes an insulating material. The sealant 216 insulates the positive electrode case 212 and the negative electrode case 214.

### (Positive Electrode)

In the present embodiment, the positive electrode current collector 222 retains the positive electrode active material layer 224. In the present embodiment, the positive electrode current collector 222 has an electrical resistance from 0.01 mΩ to 1Ω. In this way, before and after applying pressure to the electrically conductive layer (the detail of the electrically conductive layer is described below) of the positive electrode current collector 222 during the production of the positive electrode current collector 222, the variation in the voltage measured by applying current to the electrically conductive layer under a particular measurement condition is suppressed to, for example, less than 100 mV. The positive electrode current collector 222 may have an electrical resistance from 0.01 mΩ to 333 mΩ or may have an electrical resistance from 0.01 mΩ to 100 mΩ.

The density of the positive electrode current collector 222 is adjusted to, for example, approximately from 1.1 to 2.0 g/cm³. In this way, for example, if the main component of the active material included in the positive electrode active material layer 224 is anthraquinone (the density: 1.3 g/cm³), anthracene (the density: 1.25 g/cm³), and/or naphthalene (the density: 1.14 g/cm³), the mass of the positive electrode 220 having the positive electrode current collector 222 and the positive electrode active material layer 224 is very light and the mass energy density of the power storage cell 112 is high.

In the present embodiment, at least a part of the positive electrode current collector 222 is formed of a material with a density lower than that of metal. At least part of the positive electrode current collector 222 may be formed of a material with a density lower than that of aluminum. For example, at least a part of the positive electrode current collector 222 is formed of resin. In this way, the power storage cell 112 may be made lighter.

In particular, when the separator 230 with a solid electrolyte as the main component is used, the mass of the separator 230 is relatively high depending on the type of solid electrolyte. Even in such a case, the increase in the total mass of the power storage cell 112 is suppressed by forming at least a part of the positive electrode current collector 222 from resin. As a result, the capacity per mass of the power storage cell 112 and the energy density of the power storage cell 112 improve.

For example, the positive electrode current collector 222 includes an electrically conductive layer including an electrically conductive material and a support layer supporting the electrically conductive layer. The details of the electrically conductive layer and the support layer are described below.

Examples of the shape of the positive electrode current collector 222 include a foil shape (sometimes referred to as a plate shape, a film shape, a sheet shape, or the like), a mesh shape, a perforated plate shape, or the like. The mesh shape and the perforated plate shape may be examples of the foil shape. The thickness of the positive electrode current collector 222 is not particularly limited but is preferably from 1 μm to 200 μm. The thickness of the positive electrode current collector 222 may be from 6 to 20 μm or may be from 4 to 10 μm.

In the present embodiment, the positive electrode active material layer 224 is formed on at least one face of the positive electrode current collector 222. The thickness of the positive electrode active material layer 224 may be from 1 to 100 μm or from 5 to 50 μm per one face of the positive electrode current collector 222.

The positive electrode active material layer 224 includes, for example, a positive electrode active material and a binding material (sometimes referred to as a binder). The positive electrode active material layer 224 may further include at least one of the electrically conductive material or the ion conductive material. The positive electrode active material layer 224 may include the positive electrode active material and the ion conductive material. In this way, the disruption of the ion conduction path and/or the electron conducting path formed inside the positive electrode active material layer 224 may be suppressed.

In one embodiment, the positive electrode active material layer 224 is formed by applying slurry including a material constituting the positive electrode active material layer 224 and solvent on at least one face of the positive electrode current collector 222 and drying the slurry. Examples of the above-described solvent include various solvent materials or the mixture thereof. The type of the above-described solvent material is not particularly limited but examples of the above-described solvent material include N-methylpyrrolidone (NMP), water, or the like.

In another embodiment, the positive electrode active material layer 224 is formed by mixing the material constituting the positive electrode active material layer 224, molding it into a sheet shape, and crimping the sheet-shaped mixture onto at least one face of the positive electrode current collector 222. When an organic compound is used as the positive electrode active material, the positive electrode current collector 222 and the positive electrode active material layer 224 may be crimped so that excessive pressure is not applied to the positive electrode active material layer 224 in the above-described crimping process.

For example, when a precursor material of the positive electrode active material layer 224 is coated on the positive electrode current collector 222 by using a coater, the pressure applied to the precursor material of the positive electrode active material layer 224 is adjusted. For example, the pressure is set so that the coating gap by the coater is 180 μm or more. The above-described coating gap may be set to be 200 μm or more. In this way, the disruption of the ion conduction path and/or the electron conducting path in the positive electrode active material layer 224 is suppressed.

### (Positive Electrode Active Material)

As the positive electrode active material included in the positive electrode active material layer 224, for example, various substances that can absorb and release carrier ions of the power storage cell 112 are used. The positive electrode active material may be an inorganic compound or may be an organic compound. These positive electrode active materials may be used alone or two or more types of the positive electrode active materials may be combined.

As described above, the positive electrode 220 has the positive electrode current collector 222 and the positive electrode active material layer 224. The mass of the positive electrode active material layer 224 may be 80% or more of the total mass of the positive electrode 220. The mass of the positive electrode active material may be 80% or more of the total mass of the positive electrode active material layer 224.

Examples of the inorganic compound used as the positive electrode active material (sometimes referred to as an inorganic positive electrode active material) include metal oxide, metal silicate, metal phosphate, metal borate, or the like. Examples of the above-described metal include transition metals such as V, Mn, Ni, Co, or the like.

For the organic compound used as the positive electrode active material (sometimes referred to as the organic positive electrode active material), various redox-active compounds are used as the organic positive electrode active material. Examples of the organic positive electrode active material include a conjugated polymer, a disulfide, a quinone, a localized radical, a delocalized radical, or the like.

The organic positive electrode active material may be an organic compound having a relatively small molecular weight and having a multi-electron transfer capacity. When the above-described organic compound is a low molecular weight compound, the molecular weight of the organic compound is, for example, 500 or less. When the above-described organic compound is a polymer or an oligomer, the molecular weight of the organic compound is, for example, 5000 or less.

(Material Other than Positive Electrode Active Material)

The binding material included in the positive electrode active material layer 224 binds the material constituting the positive electrode active material layer 224 and retains the electrode shape of the positive electrode 220. As the binding material, for example, various polymeric materials are used. Examples of the above-described polymeric material include carboxymethyl cellulose, styrene-butadiene rubber, polyvinylidene fluoride (PVdF), polytetrafluoroethylene (PTFE), polyacrylic acid, polyethylene oxide (PEO), poly(3,4-ethylenedioxythiophene) (PEDOT) and the derivatives thereof or the like.

When an organic positive electrode active material is used as the positive electrode active material, the binding material may be a material that dissolves in a solvent with the solubility of the organic positive electrode active material greater than a predetermined value. The solubility of the binding material in the above-described solvent may be equivalent to or more than the solubility of the organic positive electrode active material in the above-described solvent. In this way, for example, when the constituent material of the power storage cell 112 is reused, the dismantling process of the power storage cell 112 is easier.

The electrically conductive material included in the positive electrode active material layer 224 improves the electrical conductivity of the positive electrode active material layer 224. In this way, the resistance of the positive electrode 220 becomes lower. The electrically conductive material is not particularly limited as long as it is a material having electron conductivity. Examples of electrically conductive materials include a carbon-based material, a metal-based material, an electrically conductive polymer material, or the like. These electrically conductive materials may be used alone or two or more types of electrical conductivity enhancers may be combined.

Examples of carbon-based materials include graphite, carbon black (for example, acetylene black, Ketjen black, or the like), coke, amorphous carbon, carbon fiber, carbon nanotube, graphene, or the like. Examples of metal-based materials include aluminum, gold, silver, copper, iron, platinum, chromium, tin, indium, titanium, nickel, or the like. Examples of the electrically conductive polymer material include a polyphenylene derivative or the like.

When an organic positive electrode active material is used as the positive electrode active material, the electrically conductive material may be a material that dissolves in a solvent with the solubility of the organic positive electrode active material greater than a predetermined value. The solubility of the electrically conductive material in the above-described solvent may be equivalent to or more than the solubility of the organic positive electrode active material in the above-described solvent. In this way, for example, when the constituent material of the power storage cell 112 is reused, the dismantling process of the power storage cell 112 is easier.

The conductive material included in the positive electrode active material layer 224 improves the conductivity of the carrier ion in the positive electrode active material layer 224. As the conductive material, for example, various solid electrolytes are used. Examples of solid electrolytes include a sulfide-based solid electrolyte, an oxide-based solid electrolyte, a polymer solid electrolyte, or the like. As the conductive material, a polymer solid electrolyte may be used. Examples of polymer solid electrolytes include polyethylene oxide (PEO), poly(3,4-ethylenedioxythiophene) (PEDOT), and at least one type of compound selected from these derivatives.

As described below, in the present embodiment, the separator 230 includes a polymer solid electrolyte. The type of the polymer solid electrolyte used as the conductive material may be the same as or different from the type of the polymer solid electrolyte included in the separator 230.

When an organic positive electrode active material is used as the positive electrode active material, the conductive material may be a material that dissolves in a solvent with the solubility of the organic positive electrode active material greater than a predetermined value. The solubility of the conductive material in the above-described solvent may be equivalent to or more than the solubility of the organic positive electrode active material in the above-described solvent. In this way, for example, when the constituent material of the power storage cell 112 is reused, the dismantling process of the power storage cell 112 is easier.

### (Separator)

In the present embodiment, the separator 230 is arranged between the positive electrode 220 and the negative electrode 240 and separates the positive electrode 220 and the negative electrode 240. In addition, the separator 230 ensures the conductivity of carrier ions between the positive electrode 220 and the negative electrode 240. The thickness of the separator 230 is not particularly limited but is preferably from 10 μm to 50 μm.

In the present embodiment, the separator 230 includes a layer-shaped (sometimes referred to as board-shaped, film-shaped, sheet-shaped, or the like) solid electrolyte (sometimes referred to as a solid electrolyte layer). In this way, the solid electrolyte layer functions as the separator of the power storage cell 112.

In one embodiment, as the separator 230, the solid electrolyte layer is used. The solid electrolyte layer may be constituted of a single solid electrolyte layer or may be constituted of a plurality of solid electrolyte layers. In another embodiment, as the separator 230, a stack of one or more solid electrolyte layers and another layer including a material other than the solid electrolyte is used. The other layer may have ion conductivity. Examples of the other layer include a composite material including resin in which a plurality of through-holes are formed and an ion conductive material filling inside the through-hole.

In this way, a secondary battery including no electrolytic solution or gel electrolyte may be fabricated. As a result, even if the positive electrode active material layer 224 and/or the negative electrode active material layer 244 includes an organic active material as a main active material, the decrease in the battery life due to the organic active material dissolving in the electrolytic solution or the solvent of the gel electrolyte may be suppressed.

It is noted that the separator 230 is not limited to the above-described embodiment. For example, a porous material in which the solid electrolyte is arranged inside the pores is used as the separator 230. The separator 230 may be fabricated by immersing an appropriate support material or retention material in the gel electrolyte or the electrolytic solution to allow the gel electrolyte or the electrolytic solution to infiltrate inside the support material or the retention material and then solidifying the electrolyte arranged inside the support material or the retention material. For example, the electrolyte arranged inside the support material or the retention material is solidified by drying the support material or the retention material including the gel electrolyte or the electrolytic solution.

Examples of the electrolytic solution or the solvent of the gel electrolyte include ethylene carbonate (EC), propylene carbonate (PC), dimethyl carbonate (DMC), diethyl carbonate (DEC), ethyl methyl carbonate (EMC), butylene carbonate (BC), fluoroethylene carbonate (FEC), γ-butyrolactone, sulfolane, acetonitrile, 1,2-dimethoxymethane, 1,3-dimethoxypropane, diethyl ether, tetrahydrofuran, 2-methyltetrahydrofuran, and mixtures thereof. In particular, ethylene carbonate (EC), dimethyl carbonate (DMC), diethyl carbonate (DEC), and ethyl methyl carbonate (EMC) are widely used as the electrolytic solution or the solvent of the gel electrolyte.

### (Solid Electrolyte Layer)

In the present embodiment, the separator 230 includes a solid electrolyte layer including the polymer solid electrolyte as the main constituent material. The solid electrolyte layer includes, for example, 80% by mass or more of a true polymer solid electrolyte. If the separator 230 includes the polymer solid electrolyte as the main constituent material, the separator 230 may be joined to the positive electrode 220 and/or the negative electrode 240 without being subjected to the high pressure press process.

For example, the solid electrolyte layer is fabricated by applying slurry including the material constituting the solid electrolyte layer and solvent onto a smooth support plate and drying the slurry. Examples of the above-described solvent include various solvents or a mixture thereof. The type of the above-described solvent is not particularly limited but examples of the above-described solvent include N-methylpyrrolidone (NMP), water, methanol, or the like.

Examples of the polymer solid electrolyte constituting the solid electrolyte layer include at least one type of compound selected from polyethylene oxide (PEO), poly(3,4-ethylenedioxythiophene) (PEDOT), and the derivatives thereof. The solid electrolyte layer may be substantially constituted of a single polymer solid electrolyte or may include two or more types of polymer solid electrolyte.

### (Negative Electrode)

In the present embodiment, the negative electrode current collector 242 retains the negative electrode active material layer 244. Examples of the material of the negative electrode current collector 242 include copper, aluminum, stainless steel, nickel, titanium, an alloy thereof, or the like.

The negative electrode current collector 242 may include an electrically conductive resin. The negative electrode current collector 242 may be an electrically conductive resin. In one embodiment, the electrically conductive resin includes an electrically conductive polymer. In another embodiment, the electrically conductive resin may be a polymer including an electrical conductivity filler.

The negative electrode current collector 242 may have a constitution similar to that of the positive electrode current collector 222. For example, the negative electrode current collector 242 includes an electrically conductive layer including the electrically conductive material and a support layer supporting the electrically conductive layer. The support layer is formed of a material with a density lower than that of metal. The support layer may be formed of a material with a density lower than that of aluminum. For example, the support layer is formed of resin. In this way, the power storage cell 112 may be made lighter.

If carrier metal is used as the negative electrode active material, the carrier metal may also work as the current collector. For example, if the carrier metal of the power storage cell 112 is lithium and the negative electrode active material is lithium metal, the lithium metal is used as the current collector. In this case, the power storage cell 112 may not have to include the negative electrode current collector 242.

Examples of the shape of the negative electrode current collector 242 include a foil shape (sometimes referred to as a plate shape, a film shape, or the like), a mesh shape, a perforated plate shape, or the like. The mesh shape and the perforated plate shape may be examples of the foil shape. The thickness of the negative electrode current collector 242 is not particularly limited but may be from 1 μm to 200 μm. The thickness of the negative electrode current collector 242 may be from 4 to 20 μm or may be from 6 to 10 μm.

In the present embodiment, the negative electrode active material layer 244 is formed on at least one face of the negative electrode current collector 242. The thickness of the negative electrode active material layer 244 may be from 0 μm to 200 μm, or may be from 1 μm to 100 μm per one face of the negative electrode current collector 242.

The negative electrode active material layer 244 includes, for example, a negative electrode active material and a binding material (sometimes referred to as a binder). The negative electrode active material layer 244 may further include at least one of the electrically conductive material or the ion conductive material. The negative electrode active material layer 244 may include the negative electrode active material and the ion conductive material. In this way, the disruption of the ion conduction path and/or the electron conducting path formed inside the negative electrode active material layer 244 may be suppressed.

In one embodiment, the negative electrode active material layer 244 is fabricated by applying slurry including a material constituting the negative electrode active material layer 244 and organic solvent onto at least one face of the negative electrode current collectors 242 and drying the slurry. Examples of the above-described solvent include various solvent materials or the mixture thereof. The type of the above-described solvent material is not particularly limited but examples of the above-described solvent material include N-methylpyrrolidone (NMP), water, or the like.

In another embodiment, the negative electrode active material layer 244 is formed by mixing the material constituting the negative electrode active material layer 244, molding it into a sheet shape, and then crimping the mixture with the sheet shape onto at least one face of the negative electrode current collector 242. When the organic compound is used as a negative electrode active material, the negative electrode current collector 242 and the negative electrode active material layer 244 may be crimped such that an excessive pressure is not applied to the negative electrode active material layer 244 in the above-described crimping process.

For example, when the precursor material of the negative electrode active material layer 244 is coated onto the negative electrode current collector 242 by using a coater, the pressure applied to the precursor material of the negative electrode active material layer 244 is adjusted. For example, the pressure is set so that the coating gap by the coater is 180 μm or more. The above-described coating gap may be set to be 200 μm or more. In this way, the disruption of the ion conduction path and/or the electron conducting path in the negative electrode active material layer 244 is suppressed.

### (Negative Electrode Active Material)

As the negative electrode active material included in the negative electrode active material layer 244, for example, various substances that can absorb and release carrier ions of the power storage cell 112 are used. The negative electrode active material may be an inorganic compound or may be an organic compound. These negative electrode active materials may be used alone or two or more types of the negative electrode active material may be combined. For example, the metal foil that can release carrier ions of the power storage cell 112 is used as the negative electrode active material layer 244. In this way, the mass energy density of the power storage cell 112 improves.

In one embodiment, the negative electrode current collector 242 includes, like the positive electrode current collector 222, an electrically conductive layer including an electrically conductive material and a support layer supporting the electrically conductive layer. In this case, the mass of the negative electrode active material layer 244 may be 80% or more of the total mass of the negative electrode 240. The mass of the negative electrode active material may be 80% or more of the total mass of the negative electrode active material layer 244. In another embodiment, a metal that can release a carrier ion of the power storage cell 112 (for example, Li metal) is used as the negative electrode active material. In this case, approximately the entire negative electrode active material included in the negative electrode active material layer 244 is constituted of the metal. In addition, when the negative electrode active material layer 244 is the above-described metal with a foil shape, the negative electrode 240 may not include the negative electrode current collector 242.

Examples of the inorganic compound used as the negative electrode active material (sometimes referred to as an inorganic negative electrode active material) include (i) a carrier metal and an alloy including it, (ii) tin, silicon, and an alloy including them, (iii) silicon oxide, (iv) titanium oxide, or the like. For example, if the power storage cell 112 is a lithium secondary battery, metallic lithium, lithium titanium oxide (LTO), or the like are used as the negative electrode active material. If the material including no carrier metal is used as the negative electrode active material, carrier metal may be pre-doped into the material.

For the organic compound used as the negative electrode active material (sometimes referred to as the organic negative electrode active material), various redox-active compounds are used as the organic positive electrode active material. Examples of the organic positive electrode active material include a conjugated polymer, a disulfide, a quinone, a localized radical, a delocalized radical, or the like.

The organic positive electrode active material may be an organic compound having a relatively small molecular weight and having a multi-electron transfer capacity. When the above-described organic compound is a low molecular weight compound, the molecular weight of the organic compound is, for example, 500 or less. When the above-described organic compound is a polymer or an oligomer, the molecular weight of the organic compound is, for example, 5000 or less.

As described above, the negative electrode active material layer 244 may include a foil-shaped carrier metal. For example, the negative electrode active material layer 244 includes a lithium metal foil. In this way, the carrier metal is supplied to the power storage cell 112. The thickness of the metal foil may be from 1 to 200 μm, may be from 10 to 100 μm, or may be from 20 to 50 μm. The thickness and/or the mass of the metal foil may be determined depending on the content of the positive electrode active material in the positive electrode active material layer 224.

(Material Other than Negative Electrode Active Material)

The binding material included in the negative electrode active material layer 244 binds the material constituting the negative electrode active material layer 244 and retains the electrode shape of the negative electrode 240. As the binding material, for example, various polymeric materials are used. Examples of the above-described polymeric material include carboxymethyl cellulose, styrene-butadiene rubber, polyvinylidene fluoride (PVdF), polytetrafluoroethylene (PTFE), polyacrylic acid, polyethylene oxide (PEO), poly(3,4-ethylenedioxythiophene) (PEDOT) and the derivatives thereof or the like.

When an organic negative electrode active material is used as the negative electrode active material, the binding material may be a material that dissolves in a solvent with a solubility of the organic negative electrode active material greater than a predetermined value. The solubility of the binding material in the above-described solvent may be equivalent to or more than the solubility of the organic negative electrode active material in the above-described solvent. In this way, for example, when the constituent material of the power storage cell 112 is reused, the dismantling process of the power storage cell 112 is easier.

The electrically conductive material included in the negative electrode active material layer 244 improves the electrical conductivity of the negative electrode active material layer 244. In this way, the resistance of the negative electrode 240 becomes lower. The electrically conductive material is not particularly limited as long as it is a material having electron conductivity. Examples of electrically conductive materials include a carbon-based material, a metal-based material, an electrically conductive polymer material, or the like. These electrically conductive materials may be used alone or two or more types of electrical conductivity enhancers may be combined.

Examples of carbon-based materials include graphite, carbon black (for example, acetylene black, Ketjen black, or the like), coke, amorphous carbon, carbon fiber, carbon nanotube, graphene, or the like. Examples of metal-based materials include aluminum, gold, silver, copper, iron, platinum, chromium, tin, indium, titanium, nickel, or the like. Examples of the electrically conductive polymer material include a polyphenylene derivative or the like.

When an organic negative electrode active material is used as the negative electrode active material, the electrically conductive material may be a material that dissolves in a solvent with a solubility of the organic negative electrode active material greater than a predetermined value. The solubility of the binding material in the above-described solvent may be equivalent to or more than the solubility of the organic negative electrode active material in the above-described solvent. In this way, for example, when the constituent material of the power storage cell 112 is reused, the dismantling process of the power storage cell 112 is easier.

The conductive material included in the negative electrode active material layer 244 improves the conductivity of the carrier ion in the negative electrode active material layer 244. As the conductive material, for example, various solid electrolytes are used. Examples of solid electrolytes include a sulfide-based solid electrolyte, an oxide-based solid electrolyte, a polymer solid electrolyte, or the like. As the conductive material, a polymer solid electrolyte may be used. Examples of polymer solid electrolytes include polyethylene oxide (PEO), poly(3,4-ethylenedioxythiophene) (PEDOT), and at least one type of compound selected from these derivatives.

As described above, in the present embodiment, the separator 230 includes a polymer solid electrolyte. The type of the polymer solid electrolyte used as the conductive material may be the same as or different from the type of the polymer solid electrolyte included in the separator 230.

When an organic negative electrode active material is used as the negative electrode active material, the conductive material may be a material that dissolves in a solvent with a solubility of the organic negative electrode active material greater than a predetermined value. The solubility of the conductive material in the above-described solvent may be equivalent to or more than the solubility of the organic negative electrode active material in the above-described solvent. In this way, for example, when the constituent material of the power storage cell 112 is reused, the dismantling process of the power storage cell 112 is easier.

The positive electrode case 212 may be one example of the housing. The negative electrode case 214 may be one example of the housing. The positive electrode 220 may be one example of the electrode. The positive electrode current collector 222 may be one example of the current collector. The positive electrode active material layer 224 may be one example of the active material layer. The negative electrode 240 may be one example of the electrode. The negative electrode current collector 242 may be one example of the current collector. The negative electrode active material layer 244 may be one example of the active material layer. The organic active material may be one example of an organic compound. The organic positive electrode active material may be one example of an organic compound. The organic negative electrode active material may be one example of an organic compound.

### One Example of Another Embodiment

In the present embodiment, the detail of the power storage cell 112 is described by using an example in which the power storage cell 112 is a coin-shaped secondary battery. However, the type, structure, or the like of the power storage cell 112 is not limited to the present embodiment. In another embodiment, the power storage cell 112 may be a cylindrical battery including a wound electrode body in which a positive electrode, a separator, and a negative electrode are wound in a spiral shape. In yet another embodiment, the power storage cell 112 may be a lamination battery in which stack electrode body in which positive electrodes and negative electrodes are stacked on each other with the separators sandwiched between them is sealed with lamination. In yet another embodiment, the structure 260 includes a plurality of stacked positive electrodes 220 and the positive electrode current collectors 222 of each of the stacked positive electrodes 220 may be integrated in a part of the stacked positive electrodes 220. The structure 260 includes a plurality of stacked negative electrodes 240 and the negative electrode current collector 242 of each of the stacked negative electrodes 240 may be integrated in a part of the stacked negative electrodes 240. In this case, the structure 260 may be one example of the stack or the electrode structure.

In the present embodiment, the detail of the power storage cell 112 is described by using an example in which the negative electrode 240 has the negative electrode current collector 242 and the negative electrode active material layer 244. However, the negative electrode of the power storage cell 112 is not limited to the present embodiment. In another embodiment, a foil-shaped carrier metal functions as the negative electrode current collector 242 and the negative electrode active material layer 244. For example, if the power storage cell 112 is a lithium metal secondary battery, metallic lithium may be used as the negative electrode.

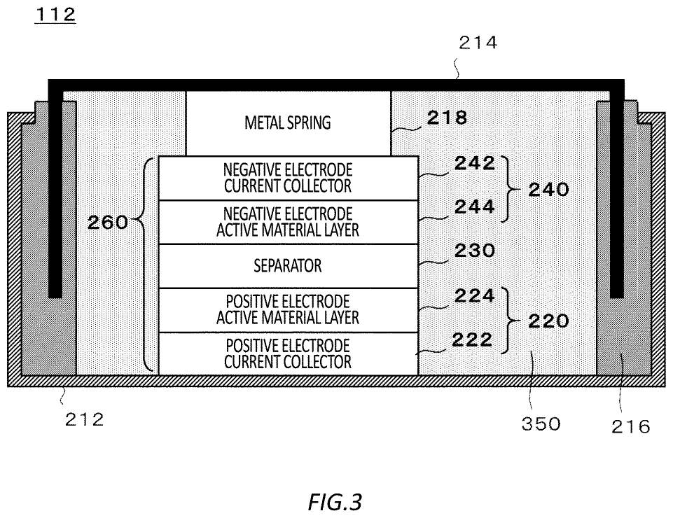

FIG. 3 schematically illustrates another example of the power storage cell 112. The power storage cell 112 described with reference to FIG. 3 is different from the power storage cell 112 described with reference to FIG. 2 in that, in addition to the metal spring 218, the positive electrode 220, the separator 230, and the negative electrode 240, the liquid or gel-like electrolyte 350 is accommodated inside the space formed by positive electrode case 212 and the negative electrode case 214 and that a material other than the solid electrolyte may be employed as the separator 230. With the exception of the above-described difference, the power storage cell 112 described with reference to FIG. 3 may have a constitution similar to that of the power storage cell 112 described with reference to FIG. 2.

The well-known electrolytic solution or gel electrolyte may be used as the liquid or gel-like electrolyte 350. The well-known separator may be used as the separator 230.

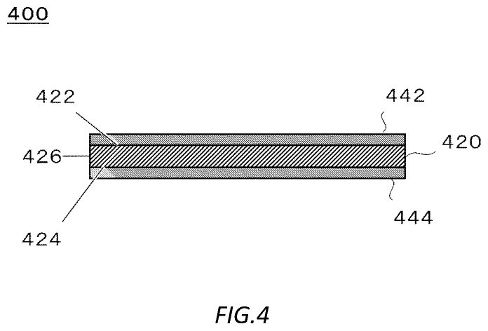

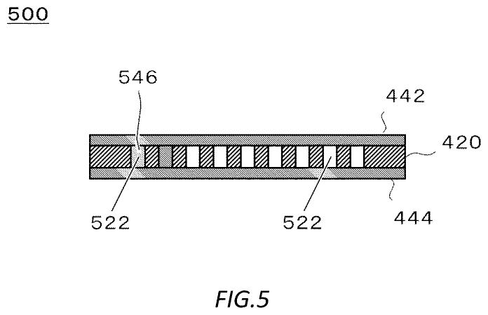

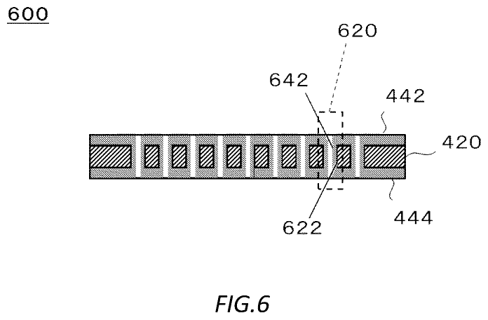

The detail of the positive electrode current collector 222 is described with reference to FIG. 4, FIG. 5, and FIG. 6. As described above, the negative electrode current collector 242 may also have a constitution similar to that of the positive electrode current collector 222. FIG. 4 schematically illustrates the cross-sectional view of the current collector 400 as one example of the positive electrode current collector 222. FIG. 5 schematically illustrates one example of the cross-sectional view of the current collector 500 as one example of the positive electrode current collector 222. FIG. 6 schematically illustrates one example of the cross-sectional view of the current collector 600 as one example of the positive electrode current collector 222.

As illustrated in FIG. 4, the current collector 400 includes a support layer 420, an electrically conductive layer 442, and an electrically conductive layer 444. In the present embodiment, the support layer 420 has a first planer surface 422, a second planer surface 424, and a side surface 426. In the present embodiment, the electrically conductive layer 442 is arranged on the first planer surface 422 of the support layer 420. The electrically conductive layer 444 is arranged on the second planer surface 424 of the support layer 420.

In the present embodiment, the support layer 420 supports the electrically conductive layer 442 and the electrically conductive layer 444. In this way, the breakage of the electrically conductive layer 442 and the electrically conductive layer 444 is suppressed. The density of the support layer 420 is lower than the density of the electrically conductive layer 442 or the electrically conductive layer 444. For example, the support layer 420 is constituted of a material with a density lower than the densities of the electrically conductive layer 442 or the electrically conductive layer 444. The support layer 420 may be a sheet-shaped resin material.

The resin material may be a thermoplastic resin or may be a thermosetting resin. The support layer 420 may be constituted of a single type of resin material or may include a plurality of types of resin material. As described above, if a part of a plurality of stacked current collectors 400 is welded, it is preferable that the resin material mainly includes thermoplastic resin or is substantially constituted of thermoplastic resin. In this way, for example, the support layer is heated before welding so that the fluidity of the support layer improves. In addition, if the support layer 420 mainly includes the thermoplastic resin or if the support layer 420 is substantially constituted of the thermoplastic resin, the plurality of current collectors 400 are welded more firmly, compared to if the support layer 420 mainly includes the thermosetting resin or if the support layer 420 is substantially constituted of the thermosetting resin. In this way, a stack having an excellent durability at the weld point and a low electrical resistance at the weld point may be fabricated.

The thermoplastic resin may be a resin having at least one property selected from the group consisting of (i) a property in which the heat conductivity at 20° C. is 0.6 W/mK or less, (ii) a property in which the specific heat capacity at 20° C. is 2500 J/kg·° C. or less, (iii) a property in which the thermal shrinkage rate at 20° C. is 1% or less, (iv) a property in which the melting point is 300° C. or less, and (v) a property in which the density at 20° C. is 1.9 g/cm³ or less. In this way, when a part of the plurality of stacked current collectors 400 are integrated by welding, the above-described concave and convex region is easily formed on the electrically conductive layer 442 and the electrically conductive layer 444.

Examples of the thermoplastic resin include polyethylene (PE), polyethylene terephthalate (PET), polyacrylonitrile (PAN), polypropylene (PP), polyphenylene sulfide (PPS), or the like. Examples of polyethylene include a high density polyethylene, a low density polyethylene, or the like. Examples of polypropylene include biaxially oriented polypropylene (OPP), cast polypropylene (CCP), or the like.

The support layer 420 may be substantially constituted of one or more types of resin material selected from a group consisting of PET, PP, and PE. In this way, the above-described concave and convex region is more easily formed on the electrically conductive layer 442 and the electrically conductive layer 444 when parts of the plurality of stacked current collectors 400 are welded than when the support layer 420 is substantially constituted of polyimide (sometimes referred to as PI). As a result, the fracture of the electrically conductive layer 442 and/or the electrically conductive layer 444 during welding is prevented.

The electrical conductivity of the support layer 420 is not particularly limited but the electrical conductivity of the support layer 420 may be lower than the electrical conductivity of the electrically conductive layer 442 or the electrically conductive layer 444. The thickness of the support layer 420 is not particularly limited but the thickness of the support layer 420 may be larger than the thickness of the electrically conductive layer 442 or the electrically conductive layer 444. As the thickness of the support layer 420 increases, the mass of the support layer 420 increases. Therefore, when the support layer 420 is a resin material with a sheet shape, the thickness of the resin material may be 10 μm or less, is preferably 7 μm or less, and more preferably 5 μm or less.

The thickness of the above-described resin material is preferably 1 μm or more and 10 μm or less at 20° C. The thickness of the above-described resin material may be 1 μm or more and 7 μm or less at 20° C. and may be 1 μm or more and 5 μm or less at 20° C.

In the present embodiment, the electrically conductive layer 442 and the electrically conductive layer 444 include an electrically conductive material. The electrically conductive material may be a material with a resistivity of 8.0×10⁻⁸ [Ω·m] or more. The electrically conductive material may be a metal. Examples of the above-described metal include aluminum, stainless steel, nickel, an alloy thereof, or the like. Examples of stainless steel include SUS-430, SUS-304, or the like. The electrically conductive material may be aluminum.

The thickness (in the figure, indicated as the length in the vertical direction) of the electrically conductive layer 442 and/or the electrically conductive layer 444 may be from 0.05 μm to 7 μm. The thickness of the electrically conductive layer 442 and/or the electrically conductive layer 444 may be from 0.05 μm to 5 μm, may be from 0.1 μm to 3 μm, may be from 0.1 μm to 2 μm, or may be from 0.5 μm to 1 μm. The thickness of the electrically conductive layer 442 and/or the electrically conductive layer 444 may be from 0.05 μm to 4 μm, may be from 0.05μ m to 3 μm, may be from 0.05 μm to 2 μm, or may be from 0.05 μm to 1 μm. The thickness of the electrically conductive layer 442 and/or the electrically conductive layer 444 is preferably from 0.1 μm to 5 μm and more preferably from 0.1 μm to 1 μm. Because commercially available aluminum foil, even relatively thin aluminum foil, has a thickness ranging from 6 to 10 μm, when the current collector 400 includes the electrically conductive layer 442 and/or the electrically conductive layer 444 having a thickness of 5 μm or less, the energy density per unit mass of the power storage cell [Wh/kg-power storage cell] improves compared to when the commercially available aluminum foil is used as the electrically conductive layer 442 and/or the electrically conductive layer 444.

At least one of the electrically conductive layer 442 and/or the electrically conductive layer 444 may be layer-shaped or foil-shaped aluminum having the above-described thickness. The layer-shaped or foil-shaped aluminum may be arranged on the surface of the support layer 420 through adhesion or may be formed on the surface of the support layer 420 through the vapor deposition method, deposition method, or the like.

If the thickness of the electrically conductive layer 442 and/or the electrically conductive layer 444 is 7 μm or less, the mass energy density of the power storage cell 112 improves. If the thickness of the electrically conductive layer 442 and/or the electrically conductive layer 444 is 5 μm or less, the mass energy density of the power storage cell 112 further improves. If the thickness of the electrically conductive layer 442 and/or the electrically conductive layer 444 is 1 μm or less, the mass energy density of the power storage cell 112 significantly improves. In general, when the thickness of the electrically conductive layer is 0.1 μm or less or less than 0.1 μm, the thickness of the electrically conductive layer 442 and/or the electrically conductive layer 444 likely causes breakage. However, the electrically conductive layer 442 and the electrically conductive layer 444 according to the present embodiment are supported by the support layer 420. Therefore, even when the thickness of the electrically conductive layer 442 and/or the electrically conductive layer 444 is approximately 0.05 to 0.1 μm, the breakage of the electrically conductive layer 442 and/or the electrically conductive layer 444 may be prevented.

As illustrated in FIG. 5, the current collector 500 is different from the current collector 400 described with reference to FIG. 4 in that the plurality of through-holes 522 are formed in the support layer 420. With the exception of the above-described difference, the current collector 500 may have a constitution similar to that of the current collector 400.

If a mere metal foil is used as the current collector, the metal foil bends during the formation of the through-holes in the current collector, sometimes making it difficult to form the through-holes. Therefore, in particular, if the active material layer is formed on both faces of the metal foil, it is difficult to form the through-holes in the current collector. In contrast, according to the present embodiment, since the electrically conductive layer is supported by a support layer such as a resin sheet, the current collector is relatively unlikely to bend even with the through-holes formed in the current collector.

According to the present embodiment, a part of the plurality of through-holes 522 is filled with the electrically conductive material 546. The electrically conductive material 546 electrically connects the electrically conductive layer 442 and the electrically conductive layer 444.

The circular equivalent bore (sometimes referred to as a circular equivalent diameter) of each of the plurality of through-holes 522 may be from 15 μm to 150 μm. The interval of the two adjacent through-holes 522 may be from 30 μm to 250 μm.

If the circular equivalent bore of the through-hole 522 is smaller than 15 μm, when an electrically conductive layer for electrically connecting the electrically conductive layer 442 and the electrically conductive layer 444 (sometimes referred to as an internal electrically conductive layer) is formed on the inner wall surface of the through-hole 522, forming an internal electrically conductive layer having a sufficient thickness may be relatively difficult or a labor for forming the internal electrically conductive layer having a sufficient thickness may increase. When the thickness of the internal electrically conductive layer is insufficient, the electrical resistance of the internal electrically conductive layer may become high. On the other hand, when the circular equivalent bore of the through-hole 522 is greater than 150 μm, the area of the support layer 420 supporting the electrically conductive layer 442 and the electrically conductive layer 444 becomes small. As a result, the total amount of the electrically conductive layer 442 and the electrically conductive layer 444 included in the current collector 500 becomes small and the electrical resistance of the electrically conductive layer 442 and the electrically conductive layer 444 may become high. In addition, when the circular equivalent bore of the through-hole 522 is greater than 150 μm, the durability of the current collector 500 may be insufficient.

The circular equivalent bore of each of the plurality of through-holes 522 (sometimes referred to as a circular equivalent diameter) may be from 15 μm to 150 μm, may be from 15 μm to 50 μm, or may be from 15 to 35 μm. The circular equivalent bore of the through-hole 522 that is not filled with the electrically conductive material 546 may be from 15 μm to 50 μm or may be from 15 to 35 μm. The circular equivalent bore of the through-hole 522 that is filled with the electrically conductive material 546 is not particularly limited. In this way, the weight reduction of the current collector 500 may be achieved while preventing the fracture of the electrically conductive layer 442 and the electrically conductive layer 444.

The ratio of the total area of the plurality of through-holes 522 in one face of the current collector 500 to the area of the profile of the one face of the current collector 500 may be 30% or more. The ratio of the total area of the through-hole 522 that is not filled with the electrically conductive material 546 in one face of the current collector 500 to the area of the profile of the one face of the current collector 500 may be 30% or more. In this way, the weight reduction of the current collector 500 may be achieved while preventing the fracture of the electrically conductive layer 442 and the electrically conductive layer 444.

As illustrated in FIG. 6, the current collector 600 is different from the current collector 500 described with reference to FIG. 5 in that the plurality of through-holes 620 extending through the support layer 420, the electrically conductive layer 442, and the electrically conductive layer 444 are formed. With the exception of the above-described difference, the current collector 500 may have a constitution similar to that of the current collector 500. For example, the through-hole 620 has a constitution similar to that of the through-hole 522 except for extending through the electrically conductive layer 442 and the electrically conductive layer 444.

In the present embodiment, the electrically conductive layer 642 is formed on the surface of the inner wall portion 622 of at least a part of the plurality of through-holes 620. The electrically conductive layer 642 may electrically connect the electrically conductive layer 442 and the electrically conductive layer 444.

In the present embodiment, the electrically conductive layer 642 includes the electrically conductive material. The electrically conductive material may be a metal. Examples of the above-described metal include aluminum, stainless steel, nickel, an alloy thereof, or the like. Examples of stainless steel include SUS-430, SUS-304, or the like. The electrically conductive material may be aluminum.

The electrically conductive layer 642 may have a plurality of layers with different main components. The electrically conductive layer 642 may have three or more layers with different main components. The electrically conductive layer 642 includes, for example, an auxiliary layer, a target layer, and a protective layer. For example, a first layer with nickel as the main component is formed on the surface of the inner wall portion 622 of the through-hole 620, a second layer with copper as the main component is formed on the first layer, and chromate coating is formed on the second layer. The thickness of the first layer may be approximately 0.1 μm, the thickness of the second layer may be approximately 1 μm, and the thickness of the chromate coating may be approximately 0.3 μm.

The current collector 400 may be one example of the sheet material. The current collector 400 may be one example of the first sheet material or the second sheet material. The support layer 420 may be one example of the support layer. The electrically conductive layer 442 may be one example of one of the first metal layers and the second metal layer. The electrically conductive layer 444 may be one example of the other of the first metal layer and the second metal layer.

The current collector 500 may be one example of the sheet material. The current collector 500 may be one example of the first sheet material or the second sheet material. The electrically conductive material 546 may be one example of the electrically conductive member.

The current collector 600 may be one example of the sheet material. The current collector 600 may be one example of the first sheet material or the second sheet material. The inner wall portion 622 may be one example of the inner wall of the through-hole. The electrically conductive layer 642 may be one example of the electrically conductive member.

### One Example of Another Embodiment

In the present embodiment, the current collector 400, the current collector 500, and the current collector 600 are described in detail by using an example in which the support layer 420 mainly includes thermoplastic resin or is substantially constituted of thermoplastic resin when parts of the plurality of stacked current collectors are welded. However, the current collector 400, the current collector 500, and the current collector 600 are not limited to the present embodiment.

In another embodiment, if the electrically conductive layer 442 and the electrically conductive layer 444 arranged on both faces of the support layer 420 are electrically connected, the support layer 420 may mainly include thermosetting resin or may be substantially constituted of thermosetting resin. In particular, according to the current collector 500, the inside of at least a part of the plurality of through-holes 522 is filled with the electrically conductive material 546. Similarly, according to the current collector 600, the electrically conductive layer 642 is formed inside at least a part of the plurality of through-holes 620. Therefore, even if the electrically conductive layer 442 and the electrically conductive layer 444 included in a single current collector do not come close to or contact to each other, parts of the plurality of stacked current collector may be integrated by welding. In addition, the support layer is heated before welding so that the fluidity of the support layer decreases. In this way, the support layer is prevented from being extruded to the surroundings of the weld point and, as a result, the volume expansion of the surroundings of the weld point may be suppressed.

In the present embodiment, with reference to FIG. 4, the current collector 400 is described in detail by using an example in which no through-hole is formed on the support layer 420. In addition, with reference to FIG. 5 and FIG. 6, the current collector 500 and the current collector 600 are described in detail by using an example in which the circular equivalent diameter of the through-hole 522 or the through-hole 620 is 15 μm to 150 μm. However, the current collector 400, the current collector 500, and the current collector 600 are not limited to the present embodiment.

In another embodiment, on the current collector 400, the current collector 500, and/or the current collector 600, one or more through-holes having the circular equivalent bore of 30 μm to 5 mm and extending through the current collector may be formed. For example, the through-holes having the circular equivalent bore of 30 μm to 5 mm are arranged at the center of gravity of the weld point or in the vicinity of the center of gravity (sometimes referred to as an approximate center). In this way, the volume of the resin material extruded from the weld point decreases. As a result, the fracture of the electrically conductive layer 442 and the electrically conductive layer 444 is further prevented. The electrically conductive layer electrically connecting the electrically conductive layer 442 and the electrically conductive layer 444 may be formed on the inner wall of the above-described through-hole. In this way, the welding of the plurality of sheet materials may be facilitated.

In another embodiment of the current collector 500, the through-hole having the circular equivalent bore of 30 μm to 5 mm may be formed instead of the through-hole 522 or along with the through-hole 522. The circular equivalent bore of the above-described through-hole may be greater than the circular equivalent bore of the through-hole 522. In another embodiment of the current collector 600, the through-hole having the circular equivalent bore of 30 μm to 5 mm may be formed instead of the through-hole 620 or along with the through-hole 620. The circular equivalent bore of the above-described through-hole may be greater than the circular equivalent bore of the through-hole 620.

In the present embodiment, the current collector 500 and the current collector 600 are described in detail by using an example in which the electrically conductive layer 442 and the electrically conductive layer 444 are electrically connected by the electrically conductive material 546 or the electrically conductive layer 642 arranged inside the through-hole formed on the support layer 420. However, the current collector 400, the current collector 500, and the current collector 600 are not limited to the present embodiment. In another embodiment, the electrically conductive layer 442 and the electrically conductive layer 444 may be electrically connected by the electrically conductive member arranged on at least a part of the side surface of the support layer 420.

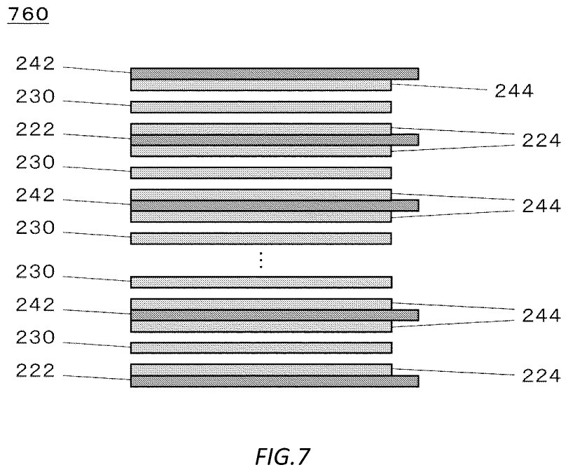

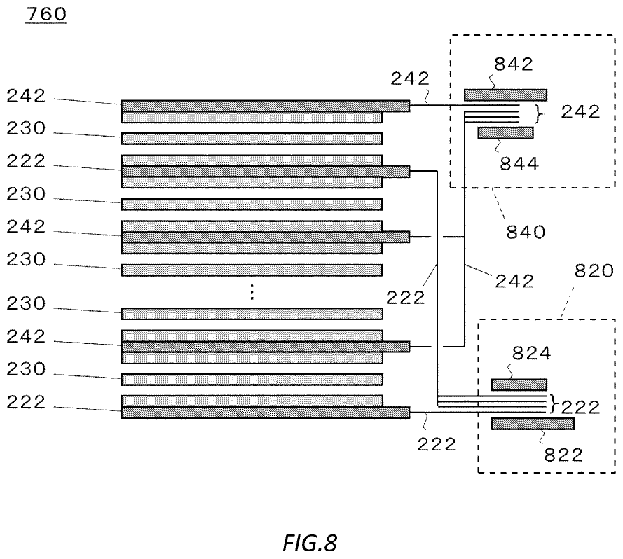

The detail of the stack structure 760 as another example of the electrode structure is described with reference to FIG. 7 and FIG. 8. FIG. 7 schematically illustrates one example of the cross-section of the stack structure 760. FIG. 8 schematically illustrates one example of the electrical connection relationship between the electrodes of the stack structure 760.

In an embodiment described with reference to FIG. 2, the detail of the structure constituting a part of the battery (sometimes referred to as an electrode structure) is described by using an example in which the positive electrode 220, the separator 230, and the negative electrode 240 are stacked in this sequence in the structure 260. However, the electrode structure is not limited to the structure 260. The stack structure 760 is different from the structure 260 in that it includes the plurality of positive electrodes 220, the plurality of separators 230, and the plurality of negative electrodes 240. With the exception of the above-described difference, the stack structure 760 may have a constitution similar to that of the structure 260.

As illustrated in FIG. 7, in the present embodiment, the stack structure 760 includes one or more positive electrodes 220, one or more negative electrodes 240, and one or more separators 230 arranged between each of the one or more positive electrodes 220 and each of the one or more negative electrodes 240. As illustrated in FIG. 7, the stack structure 760 includes the plurality of positive electrodes 220, the plurality of negative electrodes 240, and the plurality of separators 230 arranged between each of the plurality of positive electrodes 220 and each of the plurality of negative electrodes 240.

With the exception of the positive electrode 220 arranged at the outermost part of the stack structure 760, each of the plurality of positive electrodes 220 has a positive electrode active material layer 224 arranged on both faces of the positive electrode current collector 222. The positive electrode 220 arranged at the outermost part of the stack structure 760 has the positive electrode active material layer 224 arranged on one face of the positive electrode current collector 222.

With the exception of the negative electrode 240 arranged at the outermost part of the stack structure 760, each of the plurality of negative electrodes 240 has a negative electrode active material layer 244 arranged on both faces of the negative electrode current collector 242. The negative electrode 240 arranged at the outermost part of the stack structure 760 has a negative electrode active material layer 244 arranged on one face of the negative electrode current collector 242.

In the present embodiment, the positive electrode active material layer 224 is arranged in a part of the positive electrode current collector 222. For example, in the vicinity of at least one end of the positive electrode current collector 222, the positive electrode active material layer 224 is not formed on at least one face of the positive electrode current collector 222. For example, the plurality of positive electrodes 220 are stacked such that the ends on the side at which the positive electrode active material layers 224 are not formed are oriented in approximately the same direction.

In the present embodiment, the negative electrode active material layer 244 is arranged in a part of the negative electrode current collector 242. For example, in the vicinity of at least one end of the negative electrode current collector 242, the negative electrode active material layer 244 is not formed on at least one face of the negative electrode current collector 242. For example, the plurality of negative electrodes 240 are stacked such that the ends on the side at which the negative electrode active material layers 244 are not formed are oriented in approximately the same direction.

As illustrated in FIG. 8, the stack structure 760 includes a positive electrode connection 820 that electrically connects each of the plurality of positive electrodes 220. According to the present embodiment, the positive electrode connection 820 has a lead 822 and a sub-lead 824 that sandwich and support a part of the plurality of positive electrodes 220. In this way, the durability at the bonding point of the plurality of positive electrodes 220 improves.

In the present embodiment, the lead 822 and the sub-lead 824 sandwich and support the end of the positive electrode current collector 222 of each of the plurality of positive electrodes 220 and/or the vicinity of the end. As described above, in the vicinity of at least one end of each of the plurality of positive electrodes 220, the positive electrode active material layer 224 is not formed. The lead 822 and the sub-lead 824 are arranged to sandwich the plurality of stacked positive electrode current collectors 222. It is noted that, in another embodiment, the sub-lead 824 may not be used.

In the positive electrode connection 820, the plurality of positive electrodes 220 may be physically bonded by welding. For example, the plurality of stacked positive electrode current collectors 222 are physically bonded by welding so that the ends of the plurality of positive electrode current collectors 222 and/or the vicinity of the end are integrated. In this way, the plurality of positive electrodes 220 are physically bonded. At the end of the plurality of positive electrode current collectors 222 and/or the vicinity of the end, the plurality of positive electrode current collectors 222 may be integrated with the lead 822 and/or the sub-lead 824. For example, when the lead 822 and the sub-lead 824 include metal, in the above-described welding process, the plurality of electrically conductive layers 442 and the plurality of electrically conductive layers 444 included in each of the plurality of positive electrode current collectors 222, and the lead 822 and the sub-lead 824 are integrated. Examples of welding methods include ultrasonic welding, resistance welding, laser welding, or the like.

In the present embodiment, the detail of the stack structure 760 is described by using an example in which the region positioned in the vicinity of the end of the positive electrode current collector 222 of each of the plurality of positive electrodes 220 (sometimes referred to as the weld region) are welded so that the positive electrode current collector 222 of each of the plurality of the positive electrodes 220 is physically bonded. It is noted that, in another embodiment, the weld region may be arranged to include the end of the positive electrode current collector 222 of each of the plurality of positive electrodes 220.

For example, as described with reference to FIG. 4, FIG. 5, or FIG. 6, each of the plurality of positive electrode current collectors 222 has the support layer 420, and the electrically conductive layer 442 and the electrically conductive layer 444 formed on both faces of the support layer 420. For example, the electrically conductive layer 442 and the electrically conductive layer 444 are electrically connected via the electrically conductive material 546 and/or the electrically conductive layer 642. The composition or material of the support layer 420 may be the same or different among each of the plurality of positive electrode current collectors 222. The composition or material of the support layer 420 of one positive electrode current collector 222 may be the same as or different from the composition or material of the support layer 420 of the other positive electrode current collector 222.

In the present embodiment, for example, the weld region is arranged in at least a part of a region that is in the vicinity of the end of the plurality of positive electrode current collectors 222 and is sandwiched by the lead 822 and the sub-lead 824. The plane dimension of the sub-lead 824 may be greater than the plane dimension of the weld region. The plane dimension of the lead 822 may be greater than the plane dimension of the sub-lead 824.

For example, the lead 822 is constituted of a board-shaped electrically conductive material. The lead 822 may include metal or may be substantially constituted of metal. The thickness of the lead 822 may be from 1 to 300 μm, preferably from 5 to 200 μm, and more preferably from 10 to 50 μm.

The material of the sub-lead 824 is not particularly limited. The sub-lead 824 may include metal or may be substantially constituted of metal. For example, the sub-lead 824 is constituted of at least one selected from the group consisting of aluminum, nickel, stainless steel, copper, and an alloy thereof. The sub-lead 824 may be constituted of a resin material such as polypropylene, polyimide, or the like. The thickness of the sub-lead 824 may be from 1 to 300 μm, preferably from 5 to 200 μm, and more preferably from 10 to 50 μm.

Similarly, the stack structure 760 includes a negative electrode connection 840 electrically connecting each of the plurality of negative electrodes 240. According to the present embodiment, the negative electrode connection 840 has a lead 842 and a sub-lead 844 that sandwich and support parts of the plurality of negative electrodes 240. In this way, the durability of the bonding points of the plurality of negative electrodes 240 improves.

In the present embodiment, the lead 842 and the sub-lead 844 support and sandwich the end of the negative electrode current collector 242 of each of the plurality of negative electrodes 240 and/or the vicinity of the end. As described above, the negative electrode active material layer 244 is not formed in the vicinity of at least one end of each of the plurality of negative electrodes 240. The lead 842 and the sub-lead 844 are arranged to sandwich the plurality of stacked negative electrode current collectors 242. It is noted that, in another embodiment, the sub-lead 844 may not be used.

In the negative electrode connection 840, the plurality of negative electrodes 240 may be physically bonded by welding. For example, the end of the plurality of negative electrode current collectors 242 and/or the vicinity of the end are integrated by physically bonding the plurality of stacked negative electrode current collectors 242 by welding. In this way, the plurality of negative electrodes 240 are physically bonded. At the end of the plurality of negative electrode current collectors 242 and/or the vicinity of the end, the plurality of negative electrode current collectors 242, the lead 842, and/or the sub-lead 844 may be integrated. For example, when the lead 842 and the sub-lead 844 include metal, in the above-described welding process, the plurality of electrically conductive layers 442 and the plurality of electrically conductive layers 444 included in each of the plurality of negative electrode current collector 242, and the lead 842 and the sub-lead 844 are integrated. Examples of welding methods include ultrasonic welding, resistance welding, laser welding, or the like.

According to the present embodiment, the detail of the stack structure 760 is described by using an example in which the negative electrode current collector 242 of each of the plurality of negative electrodes 240 is physically bonded by welding the region positioned in the vicinity of the end of the negative electrode current collector 242 of each of the plurality of negative electrodes 240 (sometimes referred to as a weld region). It is noted that, in another embodiment, the weld region may be arranged to include the end of the negative electrode current collector 242 of each of the plurality of negative electrodes 240.

For example, as described with reference to FIG. 4, FIG. 5, or FIG. 6, each of the plurality of negative electrode current collectors 242 has the support layer 420, and the electrically conductive layer 442 and the electrically conductive layer 444 formed on both faces of the support layer 420. For example, the electrically conductive layer 442 and the electrically conductive layer 444 are electrically connected via the electrically conductive material 546 and/or the electrically conductive layer 642. The composition or material of the support layer 420 may be the same or different among each of the plurality of negative electrode current collectors 242. The composition or material of the support layer 420 of one negative electrode current collector 242 may be the same as or different from the composition or material of the support layer 420 of the other negative electrode current collector 242.

In the present embodiment, for example, the weld region is arranged in at least a part of a region that is in the vicinity of the ends of the plurality of the negative electrode current collectors 242 and is sandwiched by the lead 842 and the sub-lead 844. The plane dimension of the sub-lead 844 may be greater than the plane dimension of the weld region. The plane dimension of the lead 842 may be greater than the plane dimension of the sub-lead 844.

For example, the lead 842 is constituted of a board-shaped electrically conductive material. The lead 842 may include metal, or may be substantially constituted of metal. The thickness of the lead 842 may be from 1 to 300 μm, preferably from 5 to 200 μm, and more preferably from 10 to 50 μm.

The material of the sub-lead 844 is not particularly limited. The sub-lead 844 may include metal and may be substantially constituted of metal. For example, the sub-lead 844 is constituted of at least one selected from the group consisting of aluminum, nickel, stainless steel, copper, and an alloy thereof. The sub-lead 844 may be constituted of a resin material such as polypropylene, polyimide, or the like. The thickness of the sub-lead 844 may be from 1 to 300 μm, preferably from 5 to 200 μm, and more preferably from 10 to 50 μm.

The lead 822 may be one example of one of the first support member and the second support member. The sub-lead 824 may be one example of the other of the first support member and the second support member. The lead 842 may be one example of one of the first support member and the second support member. The sub-lead 844 may be one example of the other of the first support member and the second support member. The stack structure 760 may be one example of the electrode structure. The plurality of positive electrode current collectors 222 included in the stack structure 760 may be one example of the plurality of sheet materials that are stacked. The plurality of negative electrode current collectors 242 included in the stack structure 760 may be one example of the plurality of sheet materials that are stacked.

Among the plurality of positive electrode current collectors 222 stacked in the positive electrode connection 820, the positive electrode current collector 222 contacting the lead 822 may be one example of one of the first sheet material and the second sheet material. Among the plurality of positive electrode current collectors 222 stacked in the positive electrode connection 820, the positive electrode current collector 222 contacting the sub-lead 824 may be one example of the other of the first sheet material and the second sheet material.

Among the plurality of negative electrode current collectors 242 stacked in the negative electrode connection 840, the negative electrode current collector 242 contacting the lead 842 may be one example of one of the first sheet material and the second sheet material. Among the plurality of negative electrode current collectors 242 stacked in the negative electrode connection 840, the negative electrode current collector 242 contacting the sub-lead 844 may be one example of the other of the first sheet material and the second sheet material.

The plurality of positive electrodes 220 included in the stack structure 760 may be one example of the first electrode and the second electrode and the plurality of negative electrodes 240 included in the stack structure 760 may be one example of the third electrode and the fourth electrode. The plurality of positive electrodes 220 included in the stack structure 760 is one example of the third electrode and the fourth electrode and the plurality of negative electrodes 240 included in the stack structure 760 may be one example of the first electrode and the second electrode. Each of the plurality of separators 230 included in the stack structure 760 may be one example of the first separator, the second separator, or the third separator.

### One Example of Another Embodiment

In the present embodiment, the detail of the stack structure 760 is described by using an example in which the stack structure 760 includes the positive electrode connection 820 and the negative electrode connection 840. However, the stack structure 760 is not limited to the present embodiment. In another embodiment, the stack structure 760 may include at least one of the positive electrode connection 820 or the negative electrode connection 840.

In the present embodiment, the detail of the positive electrode connection 820 is described by using an example in which the plurality of positive electrode current collectors 222 are supported by the lead 822 and the sub-lead 824 in the positive electrode connection 820. However, the positive electrode connection 820 is not limited to the present embodiment. In another embodiment, the positive electrode connection 820 may not include the sub-lead 824. In this case, the plurality of positive electrode current collectors 222 are supported by the lead 822.

In the present embodiment, the detail of the negative electrode connection 840 is described by using an example in which the plurality of negative electrode current collectors 242 are supported by the lead 842 and the sub-lead 844 in the negative electrode connection 840. However, the negative electrode connection 840 is not limited to the present embodiment. In another embodiment, the negative electrode connection 840 may not include the sub-lead 844. In this case, the plurality of negative electrode current collectors 242 are supported by the lead 842.

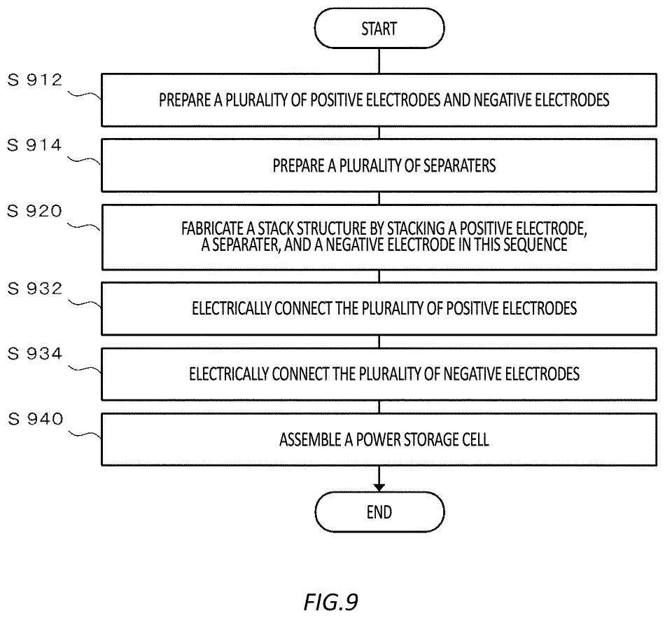

FIG. 9 schematically illustrates one example of the producing method for the power storage cell 112. In the present embodiment, the method for producing the power storage cell 112 including the stack structure 760 is described. According to the present embodiment, at first, at step 912 (step is sometimes simply referred to as S), the plurality of positive electrodes 220 and the plurality of negative electrodes 240 are prepared. The detail of the method for preparing the positive electrode 220 or the negative electrode 240 is described below. In addition, at S914, the plurality of separators 230 are prepared. Then, at S920, the positive electrode 220, the separator 230, and the negative electrode 240 are stacked in this sequence. In this way, the stack structure 760 is fabricated.

Then, at 932, the plurality of positive electrodes 220 of the stack structure 760 are electrically connected. In addition, at S934, the plurality of negative electrodes 240 of the stack structure 760 are electrically connected. Subsequently, at S940, the stack structure 760 is accommodated inside the positive electrode case 212 and the negative electrode case 214 and the power storage cell 112 is assembled.

The plurality of positive electrodes 220 prepared at S912 may be one example of the first electrode and the second electrode and the plurality of negative electrodes 240 prepared at S912 may be one example of the third electrode and the fourth electrode. The plurality of positive electrodes 220 prepared at S912 may be one example of the third electrode and the fourth electrode and the plurality of negative electrodes 240 prepared at S912 may be one example of the first electrode and the second electrode. Each of the plurality of separators 230 prepared in S914 may be one example of the first separator, the second separator, or the third separator. The stack structure 760 may be one example of the electrode structure in which the first electrode, the first separator, the third electrode, the second separator, the second electrode, the third separator, and the fourth negative electrode are stacked in this sequence.

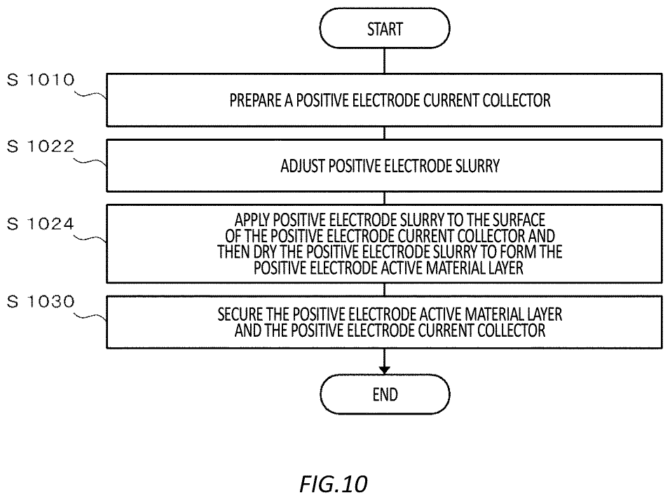

FIG. 10 schematically illustrates one example of the producing method of the positive electrode 220. According to the present embodiment, at first, at S1010, the positive electrode current collector 222 is prepared. Then, at S1022, the positive electrode slurry including the positive electrode active material and the solvent is adjusted. Then, at S1024, the positive electrode slurry is applied on the surface of the positive electrode current collector 222. In addition, the positive electrode slurry is dried. In this way, the positive electrode active material layer 224 is formed on the surface of the positive electrode current collector 222.

Then, at S1030, the positive electrode active material layer 224 and the positive electrode current collector 222 are secured. More specifically, the positive electrode active material layer 224 and the positive electrode current collector 222 are secured by applying pressure to the stacked positive electrode active material layer 224 and positive electrode current collector 222.

In one embodiment, the pressure in the securing process is set or adjusted so that (i) the change ratio of the electrical resistance (the specific resistance) of the current collector before and after the pressure is applied to the active material layer and the current collector is 50% or less or (ii) the absolute value of the difference in the electrical resistance (the specific resistance) of the current collector before and after the pressure is applied to the active material layer and the current collector is 1[Ω] or less. The pressure in the securing process may be set or adjusted so that the above-described absolute value of the difference is less than 1[Ω]. The pressure in the securing process is preferably set or adjusted so that the above-described absolute value of the difference is 500 m [Ω] or less and is more preferably set or adjusted so that the above-described absolute value of the difference is 100 m [Ω] or less. In this way, the electrically conductive layer of the current collector is prevented from being fractured. For example, the electrical resistance of the above-described current collector may be measured in a 4-terminal, 4-probe manner using a low resistivity meter (made by Nittoseiko Analytech Co., Ltd., Loresta-GX MCP-T 700).

In another embodiment, the pressure in the securing process is set or adjusted so that the value obtained by subtracting, from (i) the value of the second voltage measured by applying current to the electrically conductive layer of the current collector after the pressure is applied, (ii) the value of the first voltage measured by applying current to the electrically conductive layer of the current collector before the pressure is applied is less than 100 mV. In this way, the electrically conductive layer of the current collector is prevented from being fractured. The above-described first voltage and second voltage are measured by a low resistivity meter having, for example, a measurement function and output function for a voltage value. For example, the above-described first voltage and second voltage may be measured in a 4-terminal, 4-probe manner using a low resistivity meter (made by Nittoseiko Analytech Co., Ltd., Loresta-GX MCP-T 700).

### (the Procedure to Physically Bond the Plurality of Electrodes)

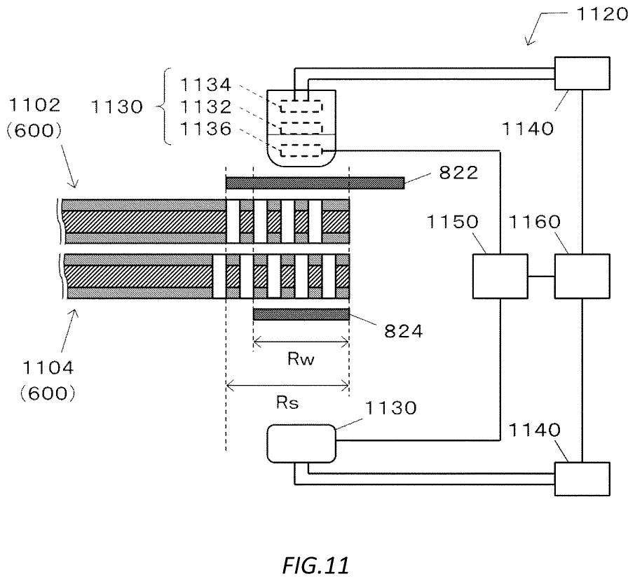

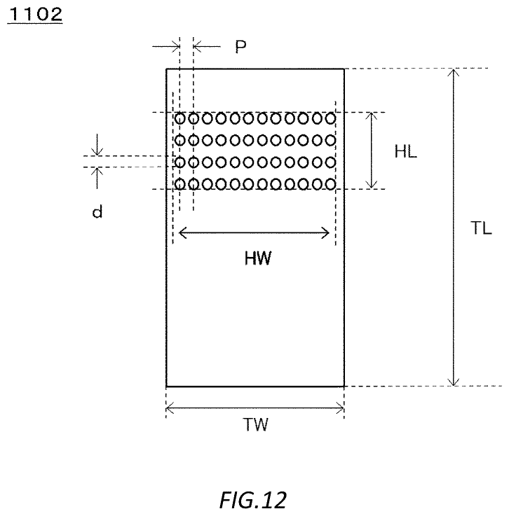

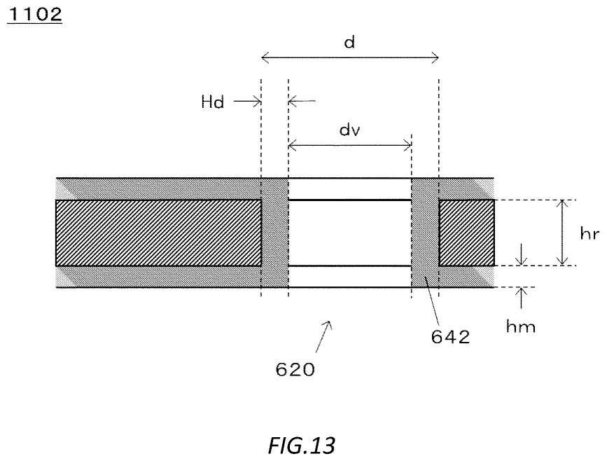

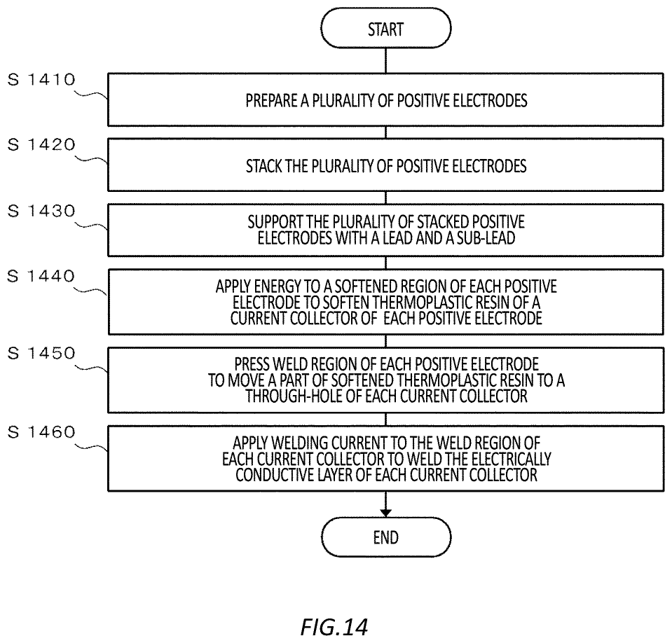

One example of the procedure for physically bonding the plurality of electrodes is described with reference to FIG. 11, FIG. 12, FIG. 13, and FIG. 14. For example, as described with reference to FIG. 8 and FIG. 9, according to one embodiment of the stack structure 760, the plurality of positive electrodes 220 are physically bonded by welding in the positive electrode connection 820. For example, the positive electrode current collector 222 of each of the plurality of positive electrodes 220 is physically bonded by welding. According to one embodiment of the stack structure 760, the plurality of negative electrodes 240 are physically bonded by welding in the negative electrode connection 840. For example, the negative electrode current collector 242 of each of the plurality of negative electrodes 240 is physically bonded by welding.

In the present embodiment, to facilitate the understanding of the procedure for physically bonding a plurality of electrodes, the detail of the procedure for physically bonding the plurality of electrodes is described by using an example in which a part of the two positive electrodes 220 are bonded by welding using the welding device 1120. It is noted that the number of electrodes bonded by welding is not limited to two. In another embodiment, three or more electrodes may be bonded by welding.

In addition, in the present embodiment, to facilitate the understanding of the procedure for physically bonding a plurality of electrodes, the detail of the procedure for physically bonding a plurality of electrodes is described by using an example in which one of the positive electrodes 220 includes the current collector 1102 and the positive electrode active material layer 224 arranged on at least one face of the current collector 1102 and the other of the positive electrodes 220 includes the current collector 1104 and the positive electrode active material layer 224 arranged on at least one face of the current collector 1104. In the present embodiment, the detail of the procedure for physically bonding the plurality of electrodes is described by using an example in which the positive electrode active material layer 224 is not formed in the vicinity of the ends of the current collector 1102 and the current collector 1104.

FIG. 11 illustrates one example of the system configuration of the welding device 1120 along with one example of the end of the current collector 1102 and the current collector 1104 and/or the vicinity. One example of the welding procedure using the welding device 1120 is described with reference to FIG. 11. More specifically, with reference to FIG. 11, one example of the procedure for fabricating the positive electrode connection 820 is described in which the welding device 1120 welds a part of the vicinity of the ends of the current collector 1102 and the current collector 1104 while pressing the ends of the current collector 1102 and the current collector 1104 and the vicinity of the ends.

### (Welding Target)

In the present embodiment, the current collector 1102 and the current collector 1104, which are the targets of the welding process, have a constitution similar to that of the current collector 600 described with reference to FIG. 6. As described with reference to FIG. 6, the current collector 600 has the support layer 420, and the electrically conductive layer 442 and the electrically conductive layer 444 formed on both faces of the support layer 420. The plurality of through-holes 620 extending through the support layer 420, the electrically conductive layer 442, and the electrically conductive layer 444 are formed on the current collector 600. The shapes of the through-holes 620 are not particularly limited. The electrically conductive layer 642 that electrically connects the electrically conductive layer 442 and the electrically conductive layer 444 is formed on the surface of the inner wall portions 622 of at least a part of the plurality of through-holes 620.

In the present embodiment, the support layers 420 of the current collector 1102 and the current collector 1104 include a thermoplastic resin material (sometimes referred to as a thermoplastic resin). In the present embodiment, the support layers 420 of the current collector 1102 and the current collector 1104 may be resin layers substantially consisting of a thermoplastic resin material. The support layer 420 of the current collector 1102 and the current collector 1104 may be an insulating layer substantially consisting of a thermoplastic resin material.

According to the present embodiment, when energy is applied to the support layers 420 of the current collector 1102 and the current collector 1104, the temperature of the support layers 420 rises and the resin material included in the support layer 420 softens. When pressure is applied to the current collector 1102 and the current collector 1104 while the resin material included in the support layers 420 softens, the resin material may move inside the support layer 420. The type of the above-described energy is not particularly limited as long as it can increase the temperature of the resin material included in the support layer 420 and/or the support layer 420. The above-described energy may be thermal energy.

The thermoplastic resin material may be a resin material with a thermal shrinkage rate of 1% or less at 25° C. Examples of thermoplastic resin materials include PE, PET, PAN, PP, PPS, or the like.

The thickness of the support layers 420 of the current collector 1102 and the current collector 1104 may be from 0.5 μm to 20 μm. The thickness of the above-described support layer 420 is preferably from 1 μm to 10 μm and more preferably from 2 μm to 8 μm.

In the present embodiment, each electrically conductive layer 442 and electrically conductive layer 444 of the current collector 1102 and the current collector 1104 include a metal material. Each electrically conductive layer 442 and electrically conductive layer 444 of the current collector 1102 and the current collector 1104 may be a metal layer substantially consisting of a metal material. The metal layer substantially consisting of a metal material includes, for example, inevitable impurities. The metal material included in the electrically conductive layer 442 and the electrically conductive layer 444 may be a single metal or may be an alloy.

The thickness of the electrically conductive layer 442 and the electrically conductive layer 444 of the current collector 1102 and the current collector 1104 may be from 0.1 μm to 10 μm. The thickness of the above-described electrically conductive layer 442 and electrically conductive layer 444 is preferably from 0.1 μm to 5 μm and more preferably from 0.1 μm to 1 μm.

In the present embodiment, each electrically conductive layer 442 and electrically conductive layer 444 of the current collector 1102 and the current collector 1104 are electrically connected. Therefore, the welding current applied by the welding device 1120 to the electrically conductive layer 442 of the current collector 1102 flows through the electrically conductive layer 442 of the current collector 1102, the electrically conductive layer 442 of the current collector 1104, and the electrically conductive layer 444 of the current collector 1104.

The electrically conductive layer 442 and the electrically conductive layer 444 may be electrically connected in any aspect. In one embodiment, the electrically conductive member that electrically connects the electrically conductive layer 442 and the electrically conductive layer 444 is arranged on the side surface 426 of the support layer 420. In another embodiment, the electrically conductive member that electrically connects the electrically conductive layer 442 and the electrically conductive layer 444 is arranged inside the support layer 420.

In the present embodiment, the plurality of through-holes 620 extending through the support layer 420, the electrically conductive layer 442, and the electrically conductive layer 444 of the current collector 1102 are formed in a part of the current collector 1102. At least a part of the plurality of through-holes 620 is arranged in the above-described weld region (represented as Rw in FIG. 11). In this way, compared to the case where the through-holes or grooves or recesses are not formed on the weld region of the support layer 420, the amount of the resin material existing in the weld region of the support layer 420 decreases. As a result, the amount of the resin material displaced due to the welding of the electrically conductive layer 442 and the electrically conductive layer 444 decreases and the volume expansion of the surroundings of the weld region due to the welding is suppressed.

According to the present embodiment, the through-holes 620 are also formed in the electrically conductive layer 442 and the electrically conductive layer 444. In this way, a part of the resin material displaced due to the welding of the electrically conductive layer 442 and the electrically conductive layer 444 may also flow into the through-hole 620 arranged in the electrically conductive layer 442 and the electrically conductive layer 444. As a result, the volume expansion of the surroundings of the weld region due to the welding is suppressed. It is noted that, in this case, the resin material remains in the weld region after welding.

At least a part of the plurality of through-holes 620 may be arranged in the region adjacent to the weld region (sometimes referred to as an adjacent region). As described above, due to the welding of the electrically conductive layer 442 and the electrically conductive layer 444, a part of the resin material existing in the weld region before welding is displaced and moves toward the adjacent region. According to the present embodiment, since the through-holes 620 are formed in the adjacent region, the resin material displaced due to the welding of the electrically conductive layer 442 and the electrically conductive layer 444 can flow into the through-holes 620 arranged in the adjacent region. As a result, the volume expansion of the surroundings of the weld region due to the welding is suppressed.

At least a part of the plurality of through-holes 620 may be arranged in a weld region and the region adjacent to the weld region. In this way, the volume expansion of the surroundings of the weld region due to the welding is further suppressed. The detail of the through-hole 620 is described below.

In the present embodiment, the electrically conductive layer 642 electrically connecting the electrically conductive layer 442 and the electrically conductive layer 444 is arranged on the surface of the inner wall portion 622 of at least a part of the plurality of through-holes 620. The type and structure of the material constituting the electrically conductive layer 642 is not particularly limited as long as it is the substance has electrical conductivity. The electrically conductive layer 642 may include the metal material. The electrically conductive layer 642 may be a metal layer substantially consisting of the metal material. The metal layer substantially consisting of a metal material includes, for example, inevitable impurities.

The metal material included in the electrically conductive layer 642 may be a single metal or may be an alloy. The metal material included in the electrically conductive layer 642 may be the same as or different from the metal material included in at least one of the electrically conductive layer 442 or the electrically conductive layer 444. Examples of the above-described metal material include copper, nickel, aluminum, stainless steel, the alloy thereof, or the like. Examples of stainless steel include SUS 304, SUS 430, or the like.

The electrically conductive layer 642 may include a plurality of layers. The plurality of layers may be each constituted of materials different from each other. For example, the electrically conductive layer 642 may include a layer for electrically connecting the electrically conductive layer 442 and the electrically conductive layer 444 (sometimes referred to as a target layer) and an auxiliary layer arranged between the inner wall portion 622 of the through-hole 620 and the target layer. The auxiliary layer may be formed to enhance the electrical conductivity of the target layer and/or improve the adhesion of the through-hole 620 and the target layer. A protective layer for protecting the target layer may be formed on the surface of the target layer. Examples of the protective layer include chromate coating, zinc coating, or the like.

The electrically conductive layer 642 may include the auxiliary layer, the target layer, and the protective layer. For example, a first layer with nickel as the main component is formed on the surface of the inner wall portion 622 of the through-hole 620, a second layer with copper as the main component is formed on the first layer, and chromate coating is formed on the second layer. The thickness of the first layer may be approximately 0.1 μm, the thickness of the second layer may be approximately 1 μm, and the thickness of the chromate coating may be approximately 0.3 μm.

As described above, the thickness of the electrically conductive layer 642 of the current collector 1102 and the current collector 1104 may be more than 0 μm and 5 μm or less. The thickness of the above-described electrically conductive layer 642 is preferably from 0.1 μm to 3 μm and more preferably from 0.1 μm to 1 μm.

The electrically conductive layer 642 is formed by a well-known method. For example, the electrically conductive layer 642 is formed by electroless plating, deposition, or sputtering. The electrically conductive layer 642 may be formed by various secondary growth methods or may be formed by attaching a metal foil to the surface of the inner wall portion 622 of the through-hole 620.

Similarly, the plurality of through-holes 620 extending through the support layer 420, the electrically conductive layer 442, and the electrically conductive layer 444 of the current collector 1104 are formed in a part of the current collector 1104. The electrically conductive layer 642 electrically connecting the electrically conductive layer 442 and the electrically conductive layer 444 is arranged on the surface of the inner wall portion 622 of at least a part of the plurality of through-holes 620. The electrically conductive layer 642 of the current collector 1104 may have similar characteristics to the characteristics described in relation to the electrically conductive layer 642 of the current collector 1102.

### (Support Member)

As described above, since the electrically conductive layer 442 and the electrically conductive layer 444 according to the present embodiment is formed of the metal thin film, the durability is relatively low. Therefore, according to the present embodiment, the current collector 1102 and the current collector 1104 are supported by using the lead 822 and the sub-lead 824 described with reference to FIG. 8. In the present embodiment, the lead 822 and the sub-lead 824 are arranged to sandwich the stacked current collector 1102 and current collector 1104. In this way, the fracture of the metal thin film during welding is prevented.

As described above, a member with electrical conductivity is used as the lead 822. The lead 822 may include metal or may be substantially constituted of metal. On the other hand, a member with electrical conductivity or non-electrical conductivity is used as the sub-lead 824. The sub-lead 824 may include metal or may be substantially constituted of metal.

Before the current collector 1102 and the current collector 1104 are welded, the through-hole extending through the lead 822 and the sub-lead 824 and the stacked current collector 1102 and current collector 1104 may be formed. In addition, the electrically conductive layer that electrically connects the lead 822, the sub-lead 824, the electrically conductive layer 442 and the electrically conductive layer 444 of the current collector 1102, the electrically conductive layer 442 and the electrically conductive layer 444 of the current collector 1104 may be formed on the inner wall of the above-described through-hole. The circular equivalent bore of the above-described through-hole may be 30 μm to 5 mm. The circular equivalent bore of the above-described through-hole may be larger than the circular equivalent bore of the through-hole 620 formed in the current collector 1102 and the current collector 1104.

### (Welding Device)

In the present embodiment, the welding device 1120 includes a pair of welding heads 1130, a heating power supply 1140, a welding power supply 1150, and a controller 1160. In the present embodiment, the welding device 1120 includes a pair of heating power supplies 1140 for supplying electrical power to each of the pair of welding heads 1130. In the present embodiment, the welding head 1130 includes a position adjustment unit 1132, a heating unit 1134, and a welding unit 1136.

In the present embodiment, the welding head 1130 applies energy to the welding target. For example, the welding head 1130 heats the welding target. The welding head 1130 presses the welding target. In this way, the welding head 1130 can apply pressure to the welding target.

In the present embodiment, the position adjustment unit 1132 adjusts the position of the welding head 1130. For example, the position adjustment unit 1132 moves the welding head 1130 to the weld region of the welding target. For example, the position adjustment unit 1132 presses the welding head 1130 against the weld region of the welding target. In this way, the welding head 1130 presses the weld region of the welding target. As a result, pressure is applied to the weld region of the welding target.

In the present embodiment, the heating unit 1134 applies energy to the softened region of the welding target. In this way, the softened region of the welding target is heated. In the present embodiment, the welding unit 1136 applies current and/or voltage to the weld region of the welding target. In this way, the weld region of the welding target is welded.

In the present embodiment, the heating power supply 1140 supplies electrical power to the heating unit 1134. In the present embodiment, the welding power supply 1150 supplies electrical power to the position adjustment unit 1132 and the welding unit 1136. In the present embodiment, the controller 1160 controls the operation of each portion of the welding device 1120.

### (Welding Procedure)

Then, one example of a procedure to weld a part of the current collector 1102 and the current collector 1104 using the welding device 1120 is described. According to the present embodiment, at first, the current collector 1102 and the current collector 1104 to be the welding targets are prepared. In one embodiment, the current collector 1102 and the current collector 1104 having the above-described structure are fabricated. In another embodiment, the current collector 1102 and the current collector 1104 having the above-described structure are purchased.

Then, the current collector 1102 and the current collector 1104 are welded and the stack in which parts of the current collector 1102 and the current collector 1104 are bonded is fabricated. More specifically, at first, the current collector 1102 and the current collector 1104 are stacked. For example, the current collector 1102 and the current collector 1104 are stacked such that the side of the second planer surface 424 of the current collector 1102 and the side of the first planer surface 422 of the current collector 1104 are in contact with each other.

In one embodiment, the plurality of through-holes 620 of the current collector 1102 and the plurality of through-holes 620 of the current collector 1104 are aligned. In another embodiment, the plurality of through-holes 620 of the current collector 1102 and the plurality of through-holes 620 of the current collector 1104 are not aligned.

Then, the current collector 1102 and the current collector 1104 are reinforced by using the lead 822 and the sub-lead 824. For example, the current collector 1102 and the current collector 1104 as well as the lead 822 and the sub-lead 824 are installed on the work position of the welding device 1120 such that the lead 822 and the sub-lead 824 sandwich the weld regions of the current collector 1102 and the current collector 1104 or the regions of the surroundings thereof.

Then, the weld regions of the current collector 1102 and the current collector 1104 are determined. In addition, the region that includes the weld regions of the stacked current collector 1102 and current collector 1104 and is to be the target of the heat process (for example, the softened region represented as Rs in FIG. 11) is determined.

For example, the user of the welding device 1120 operates the welding device 1120 to input the positions of the weld region and the softened region into the welding device 1120. The controller 1160 of the welding device 1120 controls the position adjustment unit 1132 to move the welding head 1130 to any position of the softened regions of the current collector 1102 and the current collector 1104 (for example, the weld region). The controller 1160 of the welding device 1120 controls the position adjustment unit 1132 to bring the welding head 1130 into contact with the softened regions of the current collector 1102 and the current collector 1104.

Then, the resin material of the softened region is softened by applying energy to the region (sometimes referred to as a softened region) including the weld regions of the stacked current collector 1102 and current collector 1104. For example, the controller 1160 of the welding device 1120 controls the heating power supply 1140 to supply electrical power from the heating power supply 1140 to the heating unit 1134. In this way, the heating unit 1134 increases the temperature of the welding head 1130. As a result, thermal energy is applied from the welding head 1130 to the softened regions of the current collector 1102 and the current collector 1104.

As described above, in the present embodiment, the support layers 420 of the current collector 1102 and the current collector 1104 include thermoplastic resin. When thermal energy is applied to the softened regions of the current collector 1102 and the current collector 1104, the thermoplastic resin arranged in the softened region softens.

Then, the weld region arranged in at least a part of the softened region is pressed. For example, the controller 1160 of the welding device 1120 controls the position adjustment unit 1132 to press the welding head 1130 against the weld region.

For example, the controller 1160 controls the position adjustment unit 1132 to bring each electrically conductive layer 442 and electrically conductive layer 444 of the current collector 1102 and the current collector 1104 close to each other to a distance that allows welding. At this time, pressure is also applied to the thermoplastic resin arranged between the electrically conductive layer 442 and the electrically conductive layer 444. According to the present embodiment, the thermoplastic resin softens and has moderate fluidity. Therefore, when appropriate pressure is applied to the thermoplastic resin, the thermoplastic resin moves toward the inside of the through-hole 620 formed in the electrically conductive layer 442 and the electrically conductive layer 444 of the weld region and/or the outside of the weld region.

The controller 1160 of the welding device 1120 may control the position adjustment unit 1132 to apply pressure to the stacked current collector 1102 and current collector 1104 such that the softened resin material flows into at least a part of the through-hole 620 arranged in the softened region and/or the weld region. In this way, the volume expansion of the surroundings of the weld region due to welding is significantly suppressed.

The controller 1160 may control the position adjustment unit 1132 to apply pressure to the stacked current collector 1102 and current collector 1104 such that the softened resin material fractures the electrically conductive layer 642 arranged on the surface of the inner wall portion 622 of at least a part of the through-holes 620 arranged in the softened region and/or the weld region and flows into the through-hole 620. In this way, the volume expansion of the surroundings of the weld region due to welding is significantly suppressed.

The controller 1160 of the welding device 1120 may control the position adjustment unit 1132 to apply pressure to the stacked current collector 1102 and current collector 1104 such that a region in which each metal layer has a bellows-like shape or a wrinkled shape (sometimes referred to as a concave and convex region) is formed in a part of the electrically conductive layer 442 and the electrically conductive layer 444 of the current collector 1102. In this way, the fracture of the electrically conductive layer 442 and the electrically conductive layer 444 due to welding is prevented.

The controller 1160 of the welding device 1120 may control the position adjustment unit 1132 to apply pressure to the stacked current collector 1102 and current collector 1104 such that a region in which each metal layer has a bellows-like shape or a wrinkled shape (sometimes referred to as a concave and convex region) is formed in a part of the electrically conductive layer 442 and the electrically conductive layer 444 of the current collector 1104. In this way, the fracture of the electrically conductive layer 442 and the electrically conductive layer 444 due to welding is prevented.

Then current and/or voltage is applied to the pressed weld region. In this way, each electrically conductive layer 442 and electrically conductive layer 444 of the current collector 1102 and the current collector 1104 are welded. In addition, for example, the electrically conductive layer 444 of the current collector 1102 and the electrically conductive layer 442 of the current collector 1104 are welded. As a result, a stack in which a part of each electrically conductive layer 442 and electrically conductive layer 444 of the current collector 1102 and the current collector 1104 are integrated is fabricated.

For example, the controller 1160 of the welding device 1120 controls the welding power supply 1150 to supply electrical power from the welding power supply 1150 to the welding unit 1136. In this way, current and/or voltage is applied to the pressed weld region and welding current flows into each electrically conductive layer 442 and electrically conductive layer 444 of the current collector 1102 and the current collector 1104. At this time, the controller 1160 of the welding device 1120 may control the position adjustment unit 1132 and the welding power supply 1150 to apply current and/or voltage to the weld region while further pressing the weld region.

According to the present embodiment, in each of the current collector 1102 and the current collector 1104, the electrically conductive layer 442 and the electrically conductive layer 444 are electrically connected by the electrically conductive layer 642. In this way, welding current flows into the electrically conductive layer 442 and the electrically conductive layer 444 of the current collector 1102 as well as the electrically conductive layer 442 and the electrically conductive layer 444 of the current collector 1104. As a result, four electrically conductive layers are integrated in at least a part of the weld region.

In this way, a stack in which the electrically conductive layer 442 and the electrically conductive layer 444 in the current collector 1102 are integrated with the electrically conductive layer 442 and the electrically conductive layer 444 of the current collector 1104 in the vicinity of one end of the current collector 1102 and the current collector 1104 is fabricated. There may be thermoplastic resin in the region where a part of the electrically conductive layer 442 and the electrically conductive layer 444 are integrated (sometimes referred to as an integrated region). There may be voids in the integrated region. In this way, a stack is fabricated in which at least one of the thermoplastic resin or voids are distributed inside the integrated metal.

In the integrated region, the electrically conductive layer 442 and the electrically conductive layer 444 may have shapes different from those before welding. Similarly, the thermoplastic resin included in the support layer 420 may have shapes different from those before welding. A part of the integrated region may include the electrically conductive layer 442, the electrically conductive layer 444, and/or the support layer 420 which maintains shapes approximately similar to those before welding.

If the lead 822 is constituted of metal, a stack may be fabricated in which the lead 822, the electrically conductive layer 442 and the electrically conductive layer 444 of the current collector 1102, and the electrically conductive layer 442 and the electrically conductive layer 444 of the current collector 1104 are integrated. In this case, the integrated region refers to the region in which a part of the lead 822, the electrically conductive layer 442, and the electrically conductive layer 444 are integrated. Similarly, if the lead 822 and the sub-lead 824 are constituted of metal, a stack may be fabricated in which the lead 822, the electrically conductive layer 442 and the electrically conductive layer 444 of the current collector 1102, the electrically conductive layer 442 and the electrically conductive layer 444 of the current collector 1104, and the sub-lead 824 are integrated. In this case, the integrated region refers to the region in which a part of the lead 822, the electrically conductive layer 442, the electrically conductive layer 444, and the sub-lead 824 are integrated.

As described above, the plurality of through-holes 620 are formed in the weld region of the current collector 1102. Similarly, the plurality of through-holes 620 are formed in the weld region of the current collector 1104. During welding, a part of the above-described plurality of through-holes 620 are filled with metal included in the electrically conductive layer 442, the electrically conductive layer 444, and/or the electrically conductive layer 642. In this way, a part of the plurality of through-holes 620 disappears, or the volumes of the voids of a part of the plurality of through-holes 620 decrease. Similarly, during welding, a part of the plurality of through-holes 620 is filled with the thermoplastic resin included in the support layer 420. In this way, a part of the plurality of through-holes 620 disappears, or the volumes of the voids of a part of the plurality of through-holes 620 decrease. As a result, depending on the condition and/or situation during welding, the thermoplastic resin and/or void may remain in the integrated region.

It is noted that the integrated region may not include the thermoplastic resin and the integrated region may not include the voids. For example, the stack that does not include the thermoplastic resin and/or the voids in the integrated region may be fabricated by adjusting the extent of the press during welding and/or the magnitude of the welding current.

### (Resin Content in the Integrated Region)

The ratio of the volume of the resin existing in the integrated region to the volume of the metal existing in the integrated region (sometimes referred to as the resin content in the integrated region) may be 0% or may be from 0.1 to 50%. The above-described resin content is preferably from 0.1 to 50%, more preferably from 1 to 30%, and even more preferably from 5 to 20%.

If the lead 822 and/or the sub-lead 824 are constituted of metal and a stack is fabricated in which the lead 822 and/or the sub-lead 824, the electrically conductive layer 442 and the electrically conductive layer 444 of the current collector 1102, and the electrically conductive layer 442 and the electrically conductive layer 444 of the current collector 1104 are integrated, the resin content in the integrated region may be derived as the ratio of the volume of the resin existing in the integrated region to the volume of the metal derived from the electrically conductive layer 442 and the electrically conductive layer 444 existing in the integrated region. The volume of the metal derived from the electrically conductive layer 442, the electrically conductive layer 444, and/or the electrically conductive layer 642 may be the volume of the same type of metal as the component mainly constituting the electrically conductive layer 442, the electrically conductive layer 444, and/or the electrically conductive layer 642 (sometimes referred to as a main component).

For example, if the main component of the lead 822 and/or the sub-lead 824 is different from the main component of the electrically conductive layer 442 and the electrically conductive layer 444 of the current collector 1102 as well as the main component of the electrically conductive layer 442 and the electrically conductive layer 444 of the current collector 1104, the boundary between the metal derived from the lead 822 and/or the sub-lead 824 and the metal derived from the electrically conductive layer 442 and/or the electrically conductive layer 444 is determined by, for example, observing, using the scanning electron microscope (SEM), the cross-section obtained by cutting the integrated region by a plane approximately parallel to the stack direction (the vertical direction in FIG. 11) of the plurality of integrated current collectors. The same applies to the case where the main component of the lead 822 and/or the sub-lead 824 is different from the main component of the electrically conductive layer 442, the electrically conductive layer 444, and the electrically conductive layer 642 of the current collector 1102 as well as the main component of the electrically conductive layer 442, the electrically conductive layer 444, and the electrically conductive layer 642 of the current collector 1104.

For example, if the main component of the lead 822 and/or the sub-lead 824 is the same as or similar to the main component of the electrically conductive layer 442 and/or the electrically conductive layer 444, it is considered that determining the position of the above-described boundary based on the observation of the cross-section of the integrated region is relatively difficult. In this case, the position of the above-described boundary may be estimated based on the position of the boundary between the lead 822 and/or the sub-lead 824 and the electrically conductive layer 442 and/or the electrically conductive layer 444 in the adjacent region where the metal derived from the lead 822 and/or the sub-lead 824 is not integrated with the metal derived from the electrically conductive layer 442 and/or the electrically conductive layer 444.

The above-described resin content may be from 5 to 50%. The above-described resin content is preferably from 5 to 30% and more preferably from 5 to 20%. According to the present embodiment, the through-holes 620 are formed in the softened region and/or the weld region. Therefore, the above-described resin content may be higher, compared to the case where the through-holes 620 are not formed in the softened region and/or the weld region. In addition, a relatively high resin content may imply that the through-holes 620 are formed in the softened region and/or the weld region.

If the resin content exceeds 50%, the welding is insufficient and the durability of the welding unit decreases. In addition, if the resin content exceeds 50%, the electrical conductivity between the lead 822 and the sub-lead 824 decreases, and the resistance increases. On the other hand, if an appropriate amount of resin is included in the integrated region, the resin may contribute to the ensured durability of the integrated region. In addition, in this case, since a sufficient amount of electrically conductive material is included in the integrated region, the electrical conductivity of the integrated region is ensured.

The ratio of the volume of the thermoplastic resin derived from the support layer 420, among the resin existing in the integrated region, to the volume of the metal derived from the electrically conductive layer 442, the electrically conductive layer 444, and/or the electrically conductive layer 642, among the metal existing in the integrated region, may be from 5 to 50%. The above-described ratio may be from 10 to 50%, may be from 10 to 40%, or may be from 5 to 30%. As described above, for example, if the main component of the lead 822 and/or the sub-lead 824 is different from the main component of the electrically conductive layer 442 and the electrically conductive layer 444 of the current collector 1102 as well as the main component of the electrically conductive layer 442 and the electrically conductive layer 444 of the current collector 1104, the volume of the metal derived from the electrically conductive layer 442, the electrically conductive layer 444, and/or the electrically conductive layer 642, among the metal existing in the integrated region, may be relatively easily determined through observation using the scanning electron microscope.

As described above, the resin content in the integrated region is determined by, for example, observing, using the scanning electron microscope (SEM), the cross-section obtained by cutting the integrated region by the plane approximately parallel to the stack direction of the plurality of integrated current collectors (the vertical direction in FIG. 11). The above-described cross-section (that is, the plane observed with the SEM) may be the cross-section obtained by cutting the integrated region by a plane (the plane extending through the page in the approximately perpendicular direction in FIG. 11) that is approximately parallel to the stack direction of the plurality of integrated current collectors (the vertical direction in FIG. 11) and that is approximately perpendicular to the extending direction of the plurality of current collectors (the horizontal direction in FIG. 11).

The above-described cross-section may be a plane passing through the approximate center of the integrated region. The approximate center of the integrated region is determined by, for example, visually observing the surface on one side of the plurality of integrated current collectors (for example, the first planer surface 422). The above-described surface may be the surface on the side of the first planer surface 422 of the current collector arranged on the top surface or may be the surface on the side of the second planer surface 424 of the current collector arranged at the bottom surface.

In the step of cutting the integrated region of the stack to observe the cross-section of the stack using the SEM, the approximate position of the outer edge of the integrated region is determined by, for example, visually confirming the weld mark. It is noted that the exact position of the outer edge of the integrated region is determined by, for example, observing the cross-section using the SEM after the integrated region of the stack is cut.

According to one embodiment, appropriate adjustment of the magnification of the SEM image in the vicinity of the outer edge of the integrated region may allow visual distinction between the region in which the plurality of electrically conductive layers are integrated and the region in which the plurality of electrically conductive layers are only in contact but are not integrated. In this way, the position of the outer edge (sometimes referred to as an end) of the integrated region may be determined.

According to another embodiment, the position of the outer edge of the integrated region is determined based on the length of the stack in the stack direction of the plurality of current collectors (sometimes referred to as the thickness). For example, the position where the thickness in vicinity of the end of the integrated region is 1.1 times greater than the average value of the thickness in the vicinity of the center of the integrated region is determined as the end of the integrated region. The thickness of the vicinity of the center of the integrated region is determined by, for example, averaging the thickness at the positions of three points in the SEM image of the vicinity of the center of the integrated region. The measurement interval is set as appropriate so that the above-described number of measurement values are obtained.

If there are a plurality of positions having a thickness 1.1 times greater than the average value of the thickness of the integrated region, the end of the integrated region may be the position closest to the center of the integrated region among the plurality of positions. If the plurality of current collectors are welded using the lead and the sub-lead, the thickness of the integrated region may be the distance of the lead and the sub-lead.

The resin content in the integrated region is derived as, for example, the ratio of the area of the thermoplastic resin in the SEM image to the area of metal in the SEM image. The resin content in the integrated region may be derived as the average value of the resin content obtained by observing each of the plurality of SEMs with different observation positions in a single cross-section. For example, at first, five resin contents corresponding to each of the five SEM images are derived. Then, three measurement values excluding the highest and lowest measurement values among the five measurement values of the resin contents are averaged. In this way, the resin content in the integrated region is determined. One of the plurality of SEM images may be an image of the approximate center of the integrated region.

### (the Void Ratio in the Integrated Region)

The ratio of the volume of voids to the volume of the metal in the integrated region (sometimes referred to as the void ratio in the integrated region) may be from 0 to 10%. The void ratio in the integrated region is preferably from 0 to 10%, more preferably from 0.1 to 8%, and more preferably from 0.1 to 5%. The void ratio in the integrated region may exceed 10%. However, as the void ratio increases, the durability and electrical conductivity of the integrated region decrease. Therefore, the void ratio in the integrated region is preferably 10% or less.

According to the present embodiment, the through-holes 620 are formed in the softened region and/or the weld region. Therefore, the above-described void ratio may be higher, compared to the case where the through-holes 620 are not formed in the softened region and/or the weld region. In addition, a relatively high void ratio may imply that the through-holes 620 are formed in the softened region and/or the weld region.

The void ratio in the integrated region is determined by, for example, observing, by using the scanning electron microscope (SEM), the cross-section obtained by cutting the integrated region by the plane approximately parallel to the stack direction of the plurality of integrated current collectors (the vertical direction in FIG. 11). The void ratio in the integrated region is determined through, for example, a procedure similar to that for the resin content in the integrated region.

As described above, the above-described stack constitutes a part of the stack structure 760. As described with reference to FIG. 8, the stack structure 760 includes a structure in which a first positive electrode 220, a first separator 230, a first negative electrode 240, a second separator 230, a second positive electrode 220, a third separator 230, and a second negative electrode 240 are stacked in this sequence.

In the present embodiment, the positive electrode connection 820 including the stack of the current collector 1102 and the current collector 1104 is arranged in the vicinity of the ends of the positive electrode 220 including the current collector 1102 and the positive electrode 220 including the current collector 1104. Therefore, according to the present embodiment, two positive electrodes 220 are integrated in the vicinity of these ends. In this way, the mass of the power storage cell 112 decreases compared to the case where a tab is provided on each of the plurality of current collectors and the tabs of the plurality of current collectors are electrically connected via wiring. As a result, the power storage cell 112 with a high mass energy density is obtained.

In the present embodiment, before the above-described softening process or pressing process for the thermoplastic resin is performed, the current collector 1102 and the current collector 1104 are reinforced using the lead 822 and the sub-lead 824. In this way, the fracture of the electrically conductive layer 442 and/or the electrically conductive layer 444 due to the pressure applied during welding is prevented.

The current collector 1102 may be one example of the sheet material, the first sheet material, or the second sheet material. The current collector 1104 may be one example of the sheet material, the first sheet material, or the second sheet material.

One example of the plurality of through-holes 620 arranged on the current collector 1102 is described with reference to FIG. 12 and FIG. 13. FIG. 12 is one example of the top view of the current collector 1102. FIG. 13 is one example of the cross-sectional view of the current collector 1102. It is noted that the plurality of through-holes 620 arranged on the current collector 1104 may have characteristics similar to those of the plurality of through-holes 620 arranged on the current collector 1102.

As illustrated in FIG. 12, in the present embodiment, the diameter d of each of the plurality of through-holes 620 (for example, the circular equivalent diameter) may be from 15 μm to 150 μm. If the diameter d is less than 15 μm, the thermoplastic resin is less likely to flow into the through-hole 620. In addition, since the volume of the through-hole 620 is small, the volume expansion rate of the welded stack is high. On the other hand, if the diameter d exceeds 150 μm, the durability of the current collector 1102 is low and the current collector 1102 is likely to fracture during welding.

In the present embodiment, the interval of the two adjacent through-holes 620 (sometimes referred to as a pitch) P may be from 30 μm to 250 μm. If the pitch P is less than 30 μm, the durability of the current collector 1102 is low and the current collector 1102 is likely to fracture during welding. In addition, the resistance of the current collector 1102 is high. On the other hand, if the pitch P exceeds 250 μm, the total amount of the thermoplastic resin existing in the weld region may also become relatively high. Therefore, the volume expansion rate of the welded stack may become high. In contrast, moderately forming the through-hole 620 in the weld region reduces the total amount of the thermoplastic resin existing in the weld region before welding. As a result, the volume expansion of the adjacent region due to welding may be prevented.

The length TL of the current collector 1102 in the extending direction may be greater than the length HL of the region where the plurality of through-holes 620 are formed (sometimes referred to as a through-hole zone), or TL and HL may be approximately the same. The length TW in the direction (sometimes referred to as the width direction) approximately perpendicular to the extending direction of the current collector 1102 may be greater than the length HW in the width direction of the through-hole zone, or TW and HW may be approximately the same.

In the present embodiment, the above-described weld region is arranged inside the through-hole zone. At least a part of the above-described softened region is arranged inside the through-hole zone. For example, the above-described adjacent region is arranged inside the through-hole zone. The above-described softened region may be arranged inside the through-hole zone.

The size of the softened region Rs may be determined based on the size of the weld region Rw. The size of the softened region Rs is determined such that, for example, the ratio of the area Ss of the softened region Rs in the first planer surface 422 or the second planer surface 424 of the support layer 420 to the area Sw of the weld region Rw in the first planer surface 422 or the second planer surface 424 of the support layer 420 is indicated by the Expression 1 described below. In this way, the volume of the through-hole 620 existing inside the softened region Rs is equal to or more than the volume of the thermoplastic resin existing inside the weld region Rw.

$$Ss / Sw \geq ( 1 - ε w + ε out ) / ε out \qquad ( Expression 1 )$$

In Expression 1, εw represents the void ratio of the plurality of through-holes in the weld region Rw. εout represents the void ratio of the plurality of through-holes in the region other than the weld region Rw of the softened region Rs. εw and εout are the void ratios at the temperature for the softening process.

The void ratio εw of the plurality of through-holes in the weld region Rw may be 10% or more at the temperature for the softening process. The void ratio εw at the temperature for the softening process is preferably 20% or more, and more preferably 30% or more.

As illustrated in FIG. 13, the electrically conductive layer 642 is formed inside the through-hole 620. Therefore, the diameter dv of the space formed inside the through-hole 620 is smaller than the diameter d of the through-hole 620.

As described above, the thickness Hd of the electrically conductive layer 642 may be from 0 μm to 5 μm. The thickness Hd of the above-described electrically conductive layer 642 is preferably from 0.1 μm to 3 μm and more preferably from 0.1 μm to 1μ m.

As described above, the thickness hr of the support layer 420 may be from 0.5 μm to 20 μm. The thickness hr of the above-described support layer 420 is preferably from 1 μm to 10 μm and more preferably from 2 μm to 8 μm.

As described above, the thickness hm of the electrically conductive layer 442 and the electrically conductive layer 444 may be from 0.1 μm to 10 μm. The thickness hm of the above-described electrically conductive layer 442 and electrically conductive layer 444 is preferably from 0.1 μm to 5 μm and more preferably from 0.1 μm to 1 μm.

FIG. 14 illustrates one example of a procedure for fabricating the stack structure 760 in which parts of the positive electrode current collector 222 of each of the plurality of positive electrodes 220 are integrated. As described with reference to FIG. 11, according to the present embodiment, at first, at S1410, the plurality of positive electrodes 220 are prepared. Then, at S1420, the ends of the positive electrode current collectors 222 of the plurality of positive electrodes 220 are stacked. At S1430, the lead 822 and the sub-lead 824 are installed such that the lead 822 and the sub-lead 824 sandwich the ends of the stacked positive electrode current collectors 222.

At S1440, energy is applied to the softened region of the stacked positive electrode current collectors 222 to soften the thermoplastic resin included in the support layer 420 of the positive electrode current collector 222. At S1450, the weld regions of the stacked positive electrode current collectors 222 are pressed to move the softened thermoplastic resin into the through-hole 620 of the positive electrode current collectors 222. At S1450, welding current is applied to the weld regions of the stacked positive electrode current collectors 222 to weld the electrically conductive layer 442 and the electrically conductive layer 444 of the positive electrode current collector 222.

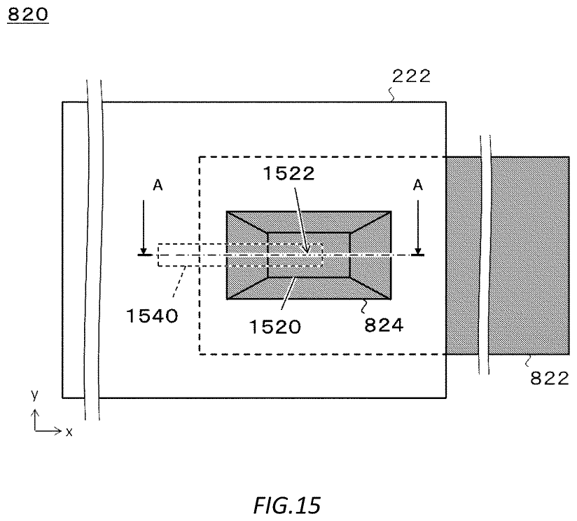

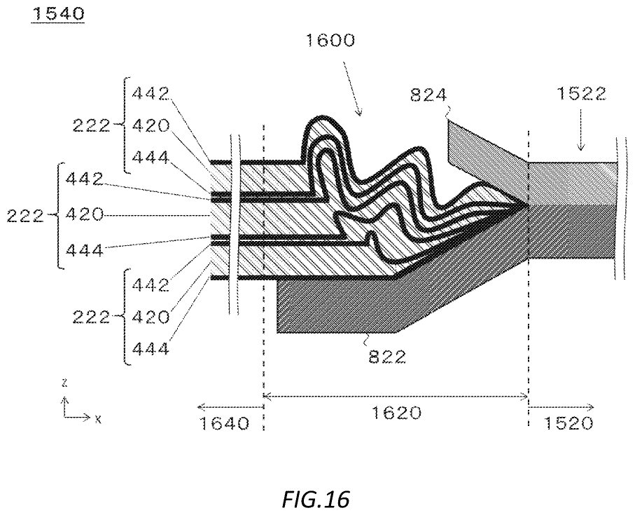

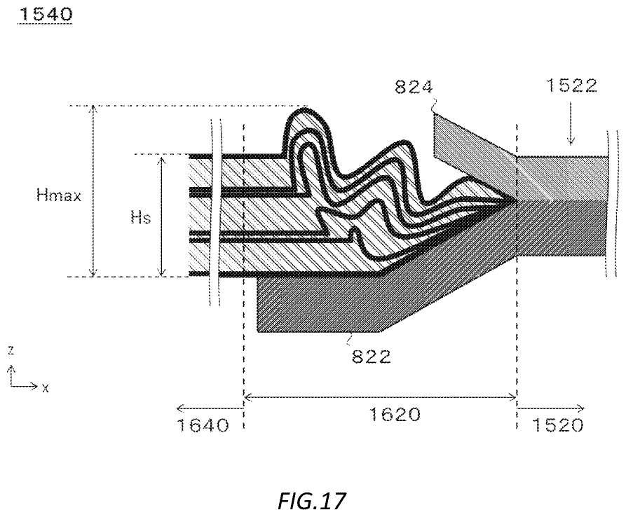

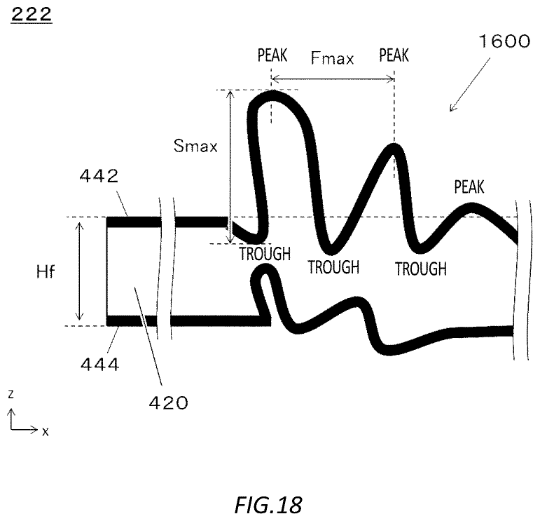

The positive electrode connection 820 in which the above-described concave and convex region is formed is described in detail by using FIG. 15, FIG. 16, FIG. 17, and FIG. 18. In the present embodiment, the positive electrode connection 820 is described in detail by using an example in which the lead 822, the three positive electrode current collectors 222, and the sub-lead 824 are integrated by welding for a purpose of facilitating understanding of the above-described concave and convex region. In the present embodiment, the lead 822 and the sub-lead 824 are arranged to sandwich the stacked three positive electrode current collectors 222. It is noted that the negative electrode connection 840 may have a constitution similar to that of the positive electrode connection 820.

FIG. 15 schematically illustrates one example of the top view of the positive electrode connection 820 after welding. FIG. 15 schematically illustrates one example of the face of the side on which the sub-lead 824 is arranged among the two faces of the positive electrode connection 820. FIG. 16 and FIG. 17 schematically illustrate one example of the cross-section of the positive electrode connection 820 after welding. FIG. 18 schematically illustrates one example of the positive electrode current collector 222 including the concave and convex region 1600. In the figure, xy plane illustrates a plane approximately perpendicular to the stack direction of the positive electrode current collector 222 (z direction in the figure).

As illustrated in FIG. 15, in the present embodiment, the lead 822 and the sub-lead 824 are arranged such that, in the vicinity of the ends of three stacked positive electrode current collectors 222, they sandwich the three positive electrode current collectors 222. An integrated region 1520 is formed in the sub-lead 824.

As described with reference to FIG. 11, the weld region including the integrated region 1520 is pressed in the process for integrating, by welding, a part of the stack including the lead 822 and the sub-lead 824 and three positive electrode current collectors 222. The sub-lead 824 has a shape recessed from the outer edge of the sub-lead 824 toward the integrated region 1520.

In a region sufficiently away from the integrated region 1520 (sometimes referred to as a smooth region), the surface of the positive electrode current collector 222 has a sufficiently low flatness. The smooth region may be a region that is sufficiently away from both ends of the lead 822 and the sub-lead 824 and where the surface of the positive electrode current collector 222 has a sufficiently low flatness. For example, the flatness of the positive electrode current collector 222 in the smooth region is approximately equal to a value obtained by considering the flatness of the sheet or film used as the support layer 420 and the manufacturing errors of the electrically conductive layer 442 and the electrically conductive layer 444.

On the other hand, in the adjacent region arranged between the integrated region and the smooth region, the resin material extruded from the integrated region in the above-described welding process forms the above-described concave and convex region in the electrically conductive layer 442 and the electrically conductive layer 444 of the positive electrode current collector 222. The above-described concave and convex region is formed outside the above-described integrated region 1520. For example, the concave and convex region is arranged to be adjacent to the integrated region.

The flatness of the electrically conductive layer 442 in the concave and convex region is higher than the flatness of the electrically conductive layer 442 in the smooth region. The ratio of the flatness of the electrically conductive layer 442 in the smooth region to the flatness of the electrically conductive layer 442 in the concave and convex region may be 0.5 to 0.9, may be 0.5 to 0.8, or may be 0.5 to 0.75. The above-described ratio may be 0.7 to 0.8. In this way, the lead 822 and the positive electrode current collector 222 may be prevented from being peeled off. In addition, the above-described variance may be prevented.

Similarly, the flatness of the electrically conductive layer 444 in the concave and convex region is higher than the flatness of the electrically conductive layer 444 in the smooth region. The ratio of the flatness of the electrically conductive layer 444 in the smooth region to the flatness of the electrically conductive layer 444 in the concave and convex region may be 0.5 to 0.9, may be 0.5 to 0.8, or may be 0.5 to 0.75. The above-described ratio may be 0.7 to 0.8. In this way, the lead 822 and the positive electrode current collector 222 may be prevented from being peeled off. In addition, the above-described variance may be prevented.

In the present embodiment, the dimension of the sub-lead 824 is smaller than the dimension of the lead 822. In this case, (i) the ratio of the flatness of the electrically conductive layer 442 in the smooth region to the flatness of the electrically conductive layer 442 in the concave and convex region may be 0.5 to 0.9 and (ii) the ratio of the flatness of the electrically conductive layer 444 in the smooth region to the flatness of the electrically conductive layer 444 in the concave and convex region may be 0.7 to 0.8.

In the concave and convex region of the electrically conductive layer 442, the electrically conductive layer 442 has a bellows-like shape or a wrinkled shape. In the concave and convex region of the electrically conductive layer 442, the electrically conductive layer 442 includes a plurality of peak portions and at least one trough portions arranged along the in-plane direction of the electrically conductive layer 442. In this way, the wrinkle is formed on the surface of the electrically conductive layer 442.

In the face approximately perpendicular to the stack direction of the positive electrode current collector 222 (in the figure, xy plane), the concave and convex region of the electrically conductive layer 442 may extend from the end of the integrated region 1520 in a single direction or may extend in a plurality of directions. The shape of the concave and convex region in the face approximately perpendicular to the stack direction of the positive electrode current collector 222 may be approximately rectangular, may be approximately circular, or may be approximately sectoral. The shape of the concave and convex region in the face approximately perpendicular to the stack direction of the positive electrode current collector 222 may be approximately concentric circular or may be approximately concentric polygonal shape.

In one embodiment, in the cross-section obtained by cutting the electrically conductive layer 442 along the first cross-section that includes the approximate center 1522 of the integrated region 1520 and is a plane approximately parallel to the stack direction (z direction in the figure) of the positive electrode current collector 222, a bellows-like shape or a wrinkled shape may be formed in a part of the electrically conductive layer 442. In another embodiment, in both of (i) the cross-section obtained by cutting the electrically conductive layer 442 along the first cross-section and (ii) the cross-section obtained by cutting the electrically conductive layer 442 along the second cross-section that includes the approximate center 1522 of the integrated region 1520 and is a plane approximately parallel to the stack direction (z direction in the figure) of the positive electrode current collector 222 and different from the first cross-section, a bellows-like shape or a wrinkled shape may be formed in a part of the electrically conductive layer 442.

Similarly, in the concave and convex region of the electrically conductive layer 444, the electrically conductive layer 444 has a bellows-like shape or a wrinkled shape. In the concave and convex region of the electrically conductive layer 444, the electrically conductive layer 444 includes a plurality of peak portions and at least one trough portions arranged along the in-plane direction of the electrically conductive layer 444. In this way, a wrinkle is formed on the surface of the electrically conductive layer 444.

In the face approximately perpendicular to the stack direction of the positive electrode current collector 222 (in the figure, xy plane), the concave and convex region of the electrically conductive layer 444 may extend from the end of the integrated region 1520 in a single direction or may extend in a plurality of directions. The shape of the concave and convex region in the face approximately perpendicular to the stack direction of the positive electrode current collector 222 may be approximately rectangular, may be approximately circular, or may be approximately sectoral. The shape of the concave and convex region in the face approximately perpendicular to the stack direction of the positive electrode current collector 222 may be approximately concentric circular or may be approximately concentric polygonal shape.

In one embodiment, in the cross-section obtained by cutting the electrically conductive layer 444 along the first cross-section that includes the approximate center 1522 of the integrated region 1520 and is a plane approximately parallel to the stack direction (z direction in the figure) of the positive electrode current collector 222, a bellows-like shape or a wrinkled shape may be formed in a part of the electrically conductive layer 444. In another embodiment, in both of (i) the cross-section obtained by cutting the electrically conductive layer 444 along the first cross-section and (ii) the cross-section obtained by cutting the electrically conductive layer 444 along the second cross-section that includes the approximate center 1522 of the integrated region 1520 and is a plane approximately parallel to the stack direction (z direction in the figure) of the positive electrode current collector 222 and different from the first cross-section, a bellows-like shape or a wrinkled shape may be formed in a part of the electrically conductive layer 444.

The plurality of electrically conductive layers 442 may include the above-described concave and convex region and the plurality of electrically conductive layers 444 may include the above-described concave and convex region. The shape of the concave and convex region formed on each of the plurality of electrically conductive layers 442 may be approximately the same as or approximately similar to each other or may be different from each other. The shape of the concave and convex region formed on each of the plurality of electrically conductive layers 444 may be approximately the same as or approximately similar to each other or may be different from each other.

It is preferable that a number of electrically conductive layers which are 30% or more of the total number of electrically conductive layers included in the stack have the above-described concave and convex region. A number of electrically conductive layers which are 80% or more of the total number of the electrically conductive layers included in the stack may have the above-described concave and convex region. In this way, the variance in the resistance among the above-described electrically conductive layers is significantly prevented.

FIG. 16 and FIG. 17 schematically illustrate one example of the A-A cross-section of the region 1540 surrounded by the dashed line in FIG. 15. As illustrated in FIG. 15, the region 1540 includes a part of the smooth region, the adjacent region, and a part of the integrated region. The region 1540 includes an approximate center 1522 of the integrated region 1520.

As illustrated in FIG. 16 and FIG. 17, in the present embodiment, three electrically conductive layers 442 included in the three positive electrode current collectors 222 have the concave and convex region 1600. In addition, two electrically conductive layers 444 included in the three positive electrode current collectors 222 have the concave and convex region 1600. In the present embodiment, the electrically conductive layer 444 contacting the lead 822 does not have the concave and convex region 1600. As illustrated in FIG. 16, in the present embodiment, the concave and convex region 1600 of each electrically conductive layer is formed in a part of the adjacent region 1620 of the stack.

As described above, the adjacent region 1620 of the stack is arranged between the integrated region 1520 of the stack and the smooth region 1640 of the stack. The adjacent region 1620 of the stack may be arranged to be adjacent to the integrated region 1520 of the stack. The adjacent region 1620 may include at least a part of the above-described softened region.

The position of the end of the integrated region 1520 is determined by the above-described approach. As described above, the smooth region 1640 is a region sufficiently away from the end of the integrated region 1520 and is a region where the surface of the stacked positive electrode current collector 222 has a sufficiently small flatness. The smooth region 1640 may be a region where the shape remains almost unchanged before and after the welding process.

Whether a particular region corresponds to the smooth region 1640 or not is determined by, for example, the procedure described below. At first, the thickness of the stacked positive electrode current collector 222 is measured at positions of three points arranged on the straight line passing through the approximate center 1522 of the integrated region 1520 (sometimes referred to as the measurement positions), the positions being outside the integrated region 1520.

The interval of the measurement positions of the above-described three points (sometimes referred to as the measurement interval) is preferably 0.1 mm or more, but the measurement interval may be set as appropriate depending on the size of the sample.

If the absolute value of the difference between the maximum value and the minimum value of the three measurement values is 5% or less of the average value of the three measurement values, the particular region may be determined as the smooth region 1640. In this case, the thickness Hs of the positive electrode current collector 222 stacked in the smooth region 1640 may be the average value of the above-described three measurement values.

As illustrated in FIG. 17, in the present embodiment, the maximum value Hmax of the thickness of the positive electrode current collector 222 stacked in the adjacent region 1620 of the stack is greater than the thickness Hs of the positive electrode current collector 222 stacked in the smooth region 1640. The value of Hmax may be 1.0 to 1.5 times higher than the value of Hs or may be 1.1 to 1.3 times higher than the value of Hs. When the value of Hmax is within the above-described numerical range, excessive pressure is prevented from being applied to the weld point. As a result, the weld durability improves.

FIG. 18 schematically illustrates one example of a cross-section of one of the three positive electrode current collectors 222 illustrated in FIG. 16 and FIG. 17. As illustrated in FIG. 18, the electrically conductive layer 442 of the above-described positive electrode current collector 222 includes a concave and convex region 1600. In the present embodiment, the concave and convex region 1600 of the electrically conductive layer 442 includes a plurality of peaks and troughs arranged along the extending direction of the electrically conductive layer 442 in the above-described cross-section (in the figure, x direction).

In the present embodiment, the electrically conductive layer 444 of the above-described positive electrode current collector 222 also includes the concave and convex region 1600. In the present embodiment, the concave and convex region 1600 of the electrically conductive layer 444 includes a plurality of peaks and troughs arranged along the extending direction of the electrically conductive layer 444 in the above-described cross-section (in the figure, x direction).

In the present embodiment, the maximum value Smax of the length of the adjacent peak and trough in the concave and convex region 1600 is greater than the thickness Hf of the single positive electrode current collector 222 in the smooth region 1640. The value of Smax may be 1.1 to 2 times the value of Hf or may be 1.2 to 1.5 times the value of Hf.

In the present embodiment, the maximum value Fmax of the interval between adjacent two peaks may be 10 to 200 μm or may be 20 to 70 μm. The value of Fmax may be 2 to 20 times the value of Hf or may be 3 to 10 times the value of Hf.

For example, the positive electrode current collector 222 has the thickness of at least 5 to 7 μm. Therefore, the observation of an SEM image, an X-ray CT image, or the like may allow distinction between the concave and convex region formed due to welding and a microscopic concave and convex formed irreversibly during the production of the electrically conductive layer 442 and/or the electrically conductive layer 444.

In the present embodiment, the number N of the peaks arranged in the concave and convex region 1600 may be two or more or may be three or more. The number N of the peaks is preferably six or more and also may be ten or more. Larger number of the peaks improves the durability of welding.

The electrically conductive layer 442 where the concave and convex region is formed may be one example of the first metal layer including the concave and convex region. The extending direction of the electrically conductive layer 442 may be one example of the in-plane direction of the metal layer. The electrically conductive layer 444 where the concave and convex region is formed may be one example of the second metal layer including the concave and convex region. The extending direction of the electrically conductive layer 444 may be one example of the in-plane direction of the metal layer. The peak of the concave and convex region 1600 may be one example of the peak portion. The trough of the concave and convex region 1600 may be one example of the trough portion.

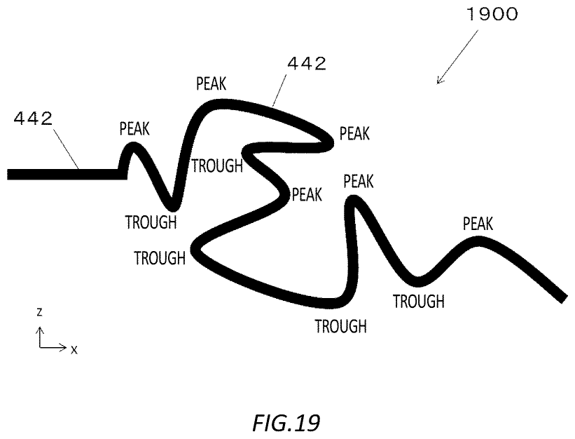

FIG. 19 schematically illustrates one example of the concave and convex region 1900. It schematically illustrates another example of one cross-section of three positive electrode current collectors 222 illustrated in FIG. 16 and FIG. 17. As illustrated in FIG. 19, the electrically conductive layer 442 of the above-described positive electrode current collector 222 includes a concave and convex region 1900.

The concave and convex region 1900 of the electrically conductive layer 442 is different from the concave and convex region 1600 described with reference to FIG. 16 to FIG. 18 in that it has a region where no trough is included between adjacent two peaks. In addition, the concave and convex region 1900 of the electrically conductive layer 442 is different from the concave and convex region 1600 described with reference to FIG. 16 to FIG. 18 in that it has a region where no peak is included between adjacent two troughs.

The concave and convex region 1900 of the electrically conductive layer 442 may have the constitution similar to that of the concave and convex region 1600 described with reference to FIG. 16 to FIG. 18 except for the above-described difference. For example, in the present embodiment, the concave and convex region 1900 of the electrically conductive layer 442 includes a plurality of peaks and troughs arranged along the extending direction of the electrically conductive layer 442 in the above-described cross-section (in the figure, x direction). In other words, the concave and convex region 1900 includes a region where a peak, a trough, and a peak are arranged in this sequence.

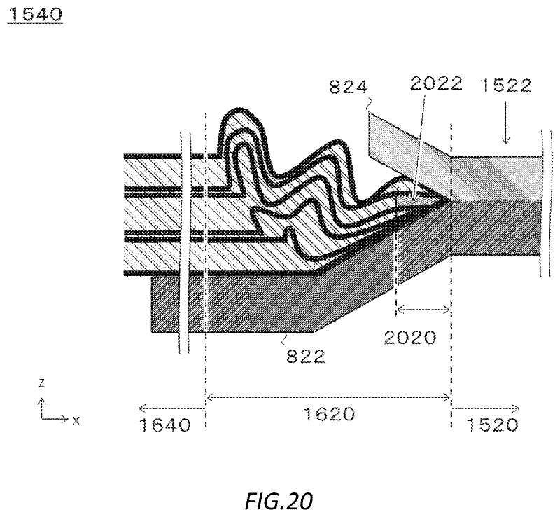

FIG. 20 schematically illustrates another example of the cross-section of the positive electrode connection 820. The positive electrode connection 820 described with reference to FIG. 20 is different from the positive electrode connection 820 described with reference to FIG. 15 to FIG. 19 in that a complex region 2020 is arranged between the integrated region 1520 and the adjacent region 1620 or in a part of the adjacent region 1620. The positive electrode connection 820 described with reference to FIG. 20 may have the constitution similar to that of the positive electrode connection 820 described with reference to FIG. 15 to FIG. 19 except for the above-described difference.

In the complex region 2020 of the stack, at least a part of the electrically conductive layer 442 and the electrically conductive layer 444 is integrated with the metal of the lead 822 and/or the sub-lead 824 while maintaining the foil shape. For example, in the complex region 2020 of the stack, the stack has a solid 2022 formed between the adjacent electrically conductive layer 442 and electrically conductive layer 444 as a result of the metal of the lead 822 and/or the sub-lead 824 being melted and solidified in the welding process.

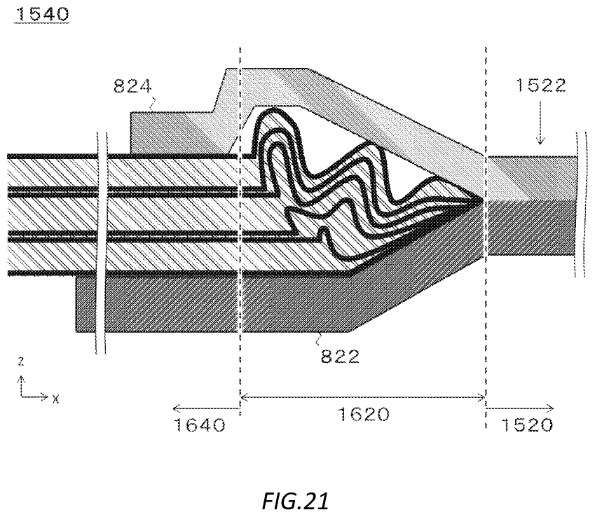

FIG. 21 schematically illustrates yet another example of the cross-section of the positive electrode connection 820. The positive electrode connection 820 described with reference to FIG. 21 is different from the positive electrode connection 820 described with reference to FIG. 15 to FIG. 20 in that the complex region 2020 is arranged at the point where the adjacent region 1620 is covered with the sub-lead 824. The positive electrode connection 820 described with reference to FIG. 21 may have a constitution similar to that of the positive electrode connection 820 described with reference to FIG. 15 to FIG. 20 except for the above-described difference.

### IMPLEMENTATION EXAMPLE

Hereinafter, implementation examples are shown, and the present invention is specifically described. The present invention is not restricted by the following implementation examples.

### (Fabrication of the Current Collector for the Negative Electrode)

### Production Example 1

Six current collectors for the negative electrode were fabricated by the described below procedure. At first, PET film (made by Toray Industries, Inc., lumirror #19-F60, thickness: 6 μm) was prepared as the support layer of the current collector for the negative electrode. Then, a Ni layer with a thickness of about 0.1 μm was formed on both faces of the PET film by electroless plating. Then, a copper layer with a thickness of 0.5 μm was formed on the Ni layer of each face of the PET film by electrolytic plating.

Then, a plurality of through-holes were formed on a part of the PET film. In this way, a through-hole zone is formed. The shape of the cross-section of each through-hole was circular and the average diameter of each through-hole was 30 μm. In addition, the pitch of the through-holes was 80 μm.

Then, a copper layer was formed on the inner wall of the through-hole by a procedure similar to the procedure for fabricating the copper layer on the PET film surface. The thickness of the copper layer was 0.5 μm. The average diameter of the space of the through-hole after the formation of the copper layer was 29 μm.

Subsequently, the PET film where the through-hole zone and the copper layer in the through-hole were formed was cut to fabricate six current collectors. The above-described PET film was cut so that each current collector has an L-shaped planar shape having a rectangular current collecting part of 38 mm×50 mm and a rectangular tab part of 10 mm×5 mm. In each current collector, the above-described PET film was cut so that the shorter side of the tab part contacts one of the shorter side of the current collecting part. In each current collector, the above-described PET film was cut so that one of the other longer sides of the tab part and one of the longer sides of the current collecting part were arranged on the same straight line.

As described with reference to FIG. 12, the above-described PET film was cut so that the through-hole zone formed on the PET film was included in the tab part. As described above, TL of the tab part of each current collector was 10 mm and TW was 5 mm. The through-hole zone was formed on the tab part of each current collector and the HL of each current collector was 2 mm and the HW was 5 mm. The distance from the edge in contact with the current collecting part among the edges of the tab part to the through-hole zone was 6 mm. The distance from the edge on the side opposite to the edge in contact with the current collecting part among the edges of the tab part to the through-hole zone was 2 mm.

In this way, six current collectors for the negative electrode were obtained. Table 1 illustrates the specification of the electrode for the negative electrode.

### Production Example 2

Six current collectors for the negative electrode were fabricated by a procedure similar to Production Example 1 except that a single through-hole with a diameter of 500 μm was formed instead of the through-hole zone composed of a plurality of through-holes. Table 1 illustrates the specification of the electrode for the negative electrode.

### Production Example 3

Six current collectors for the negative electrode were fabricated by a procedure similar to Production Example 1 except that polyimide film (made by Toray DuPont, Kapton, thickness: 6 μm) was used as the support layer of the current collectors for the negative electrode. Table 1 illustrates the specification of the electrode for the negative electrode.

### Production Example 4

Six current collectors for the negative electrode were fabricated by a procedure similar to Production Example 2 except that polyimide film (made by Toray DuPont, Kapton, thickness: 6 μm) was used as the support layer of the current collectors for the negative electrode. Table 1 illustrates the specification of the electrode for the negative electrode.

### Production Example 5

At first, Cu foil (made by AS ONE Corporation, model number 3-2349-01, thickness: 10 μm) was prepared as the support layer of the current collector for the negative electrode. Then, six current collectors were fabricated by cutting the Cu foil by a procedure similar to that of Production Example 1. Table 1 illustrates the specification of the electrode for the negative electrode.

TABLE 1

| | | | | ELECTRICALLY | | THROUGH | |
|---|---|---|---|---|---|---|---|
| | | RESIN SHEET | | CONDUCTIVE LAYER | | HOLE | PITCH |
| No | STRUCTURE | MATERIAL | THICKNESS | MATERIAL | THICKNESS | DIAMETER | INTERVAL |
| PRODUCTION | THREE- | PET | 5 μm | Cu | 0.5 μm/ | 30 μm | 80 μm |
| EXAMPLE 1 | LAYER | | | | ONE SIDE × | | |
| PRODUCTION | STRUCTURE | PET | | | BOTH SIDES | 500 μm | — |
| EXAMPLE 2 | | | | | | | |
| PRODUCTION | | PI | 6 μm | | | 30 μm | 80 μm |
| EXAMPLE 3 | | | | | | | |
| PRODUCTION | | PI | | | | 500 μm | |
| EXAMPLE 4 | | | | | | | |
| PRODUCTION | Cu FOIL | UNUSED | | Cu | 10 μm | 30 μm | 80 μm |
| EXAMPLE 5 | | | | | | | |

### Implementation Example 1

### (Fabrication of a Lithium-Ion Secondary Battery)

At first, six current collectors obtained by Production Example 1 were prepared as the current collectors for the negative electrode. Five Al foils (made by MTI Corporation, BCAF-15U180, dimension: 34 mm×46 mm, thickness: 15 μm) were prepared as the current collectors for the positive electrode. The planar shape of the Al foil was L-shape having a rectangular current collecting part of 34 mm×46 mm and a rectangular tab part of 10 mm×5 mm.

Li metal foil (made by Honjo Metals Co., Ltd., rolled lithium foil, thickness: 20 μm) of 38 mm×50 mm was prepared as the negative electrode active material. NCM 811 (made by Nichia Corporation) was prepared as the positive electrode active material. Ten SW 316F (made by Shenzhen Xingyuan Materials Co., Ltd., thickness: 10 μm) was prepared as a separator. The planar shape of the separator was a rectangle of 42 mm×54 mm.

Then, NCM 811, Denka Black (made by Denka Co., Ltd.), and PVDF (made by Kureha Trading Co., Ltd.) were added to N-methylpyrrolidone (Mitsubishi Chemical Corporation #1100) to fabricate slurry of the positive electrode active material. The mass ratio of NCM 811, Denka Black, and PVDF was 94:3:3. The above-described slurry was applied on the entire surface of the Al foil. The above-described slurry was applied on both faces of the Al foil. Subsequently, the slurry was dried to obtain the positive electrode where the positive electrode active material layer was formed on both faces of the Al foil. The thickness of the positive electrode active material layer after being dried was 50 μm per one face. In this way, five positive electrodes were obtained. The thickness of each positive electrode was 115 μm.

Then, the above-described Li metal foil was attached to both faces of the current collector obtained by Production Example 1. In this way, six negative electrodes were obtained.

Then, an electrolytic solution (made by Kishida Chemical Co., Ltd., LBG-00062) was prepared. In the above-described electrolytic solution, the solvent was a mixed solvent of the ethylene carbonate and the ethyl methyl carbonate and the volume ratio of ethylene carbonate to ethyl methyl carbonate was 1:3. In the above-described electrolytic solution, the concentration of LiPF₆ as the electrolyte was 1 mol/L.

Then, the battery structure was fabricated by stacking the negative electrode, the separator, the positive electrode, the separator, the negative electrode, the separator, the positive electrode, the separator, the negative electrode, the separator, the positive electrode, the separator, the negative electrode, the separator, the positive electrode, the separator, the negative electrode, the separator, the positive electrode, the separator, and the negative electrode in this sequence. In addition, the lead for the negative electrode was fabricated by cutting a Cu plate (made by Nets Co., Ltd., thickness: 100 μm) coated with a Ni layer with a thickness of 0.1 μm. The planar shape of the lead was a rectangle of 40 mm×15 mm. The sub-lead for the negative electrode was fabricated by cutting the Cu plate (made by Nets Co., Ltd., thickness: 30 μm) coated with a Ni layer with a thickness of 0.1 μm. The planar shape of the sub-lead was a square of 15 mm×15 mm. Similarly, the lead for the positive electrode was fabricated by cutting an Al plate (made by Nets Co., Ltd., thickness: 100 μm). The planar shape of the lead was a rectangle of 40 mm×15 mm.

Then, the stacked five tab parts for the positive electrode were integrated. Specifically, at first, five tab parts for the positive electrode were stacked and then the lead for the positive electrode was placed on the tab part of the uppermost layer. In this way, the stack that is the welding target in the welding process on the side of the positive electrode was fabricated. As described above, the current collector of the positive electrode was the Al foil and the lead for the positive electrode was the Al plate.

The above-described five sheets of Al foils and one sheet of Al plate were welded by using a lithium-ion battery stack foil welding device (made by NAG SYSTEM Co., Ltd.) including a welding head with a nugget diameter of 4 mm as the welding device. In this way, five tab parts for the positive electrode were integrated.

Then, the six stacked tab parts for the negative electrode were integrated. Specifically, at first, after the six tab parts for the negative electrode were stacked, the stacked six tab parts were sandwiched between the lead and sub-lead for the negative electrode. In this way, the stack that is the welding target in the welding process on the side of the negative electrode was fabricated.

The region of 4 mm×4 mm inside the sub-lead was set as a softened region. The position of the softened region was set such that the approximate center of the softened region coincides with the approximate center of the tab part. The region of 2 mm×2 mm inside the sub-lead was set as a weld region. The position of the weld region was set such that the approximate center of the weld region coincides with the approximate center of the softened region.

The above-described welding target (that is, the stack of the sub-lead, the six tab parts, and the lead) was placed on the work region of the welding device. A lithium-ion battery stack foil welding device (made by NAG SYSTEM Co., Ltd.) including a welding head with a nugget diameter of 4 mm was used as the welding device.

At first, the welding head of the welding device was used to press the softened region of the sub-lead to apply pressure of 1.8 kN to the softened region of the sub-lead. Then, electrical power was supplied to the heating unit of the welding device to heat the softened region. The condition for supplying electrical power during heating was: current 1.5 kA, voltage 3 V, and application time 10 ms. After the supply of electrical power to the heating unit was stopped, electrical power was supplied to the welding unit of the welding device to weld the weld region. The duration of the period between stopping the supply of the electrical power to the heating unit and starting the supply of the electrical power to the welding unit was set to 1 ms. The condition for supplying electrical power during welding was current 2.5 kA, voltage 3.5 V, and application time 20 ms. In this way, the electrode structure was fabricated.

Then, a pressure test was performed on the weld point of the negative electrode by using a heater plate press (made by Labonect Co., Ltd., PCH-100-DAH) having an 80 mm square plate. The pressure test was performed at room temperature. The pressure of 506.625 kPa was applied to the entire sub-lead. The application time of the pressure was 20 seconds.

Then, after the electrode structure for which the pressure test was completed and the above-described electrolytic solution were introduced into the lamination packaging material made of aluminum, the lamination packaging material was sealed. In this way, the test battery was fabricated. The specification of the test battery is illustrated in Table 2.

### Implementation Example 2

The test battery was fabricated by a procedure similar to that of Implementation Example 1 except that the tensile test on the weld point of the negative electrode was performed instead of the pressure test of the weld point. The specification of the test battery is illustrated in Table 2.

The tensile test was performed by the procedure described below using a tensile pressure test machine (made by A&D Company, Limited, force tester MCT-2150W). At first, the lead was set on one end of the sample jig of the tensile pressure test machine and a portion near the base of the tab part was set on the other end of the sample jig. Then, the lead and the base of the tab part were pulled with the force of 5 N/mm² by using the tensile pressure test machine. The tensile test was completed when the displacement reached 5% strain from before the test as the tensile strength was gradually increased.

### Implementation Example 3

The test battery was fabricated by a procedure similar to Implementation Example 1 except that the current collector obtained in Production Example 2 was used as the current collector for the negative electrode. The specification of the test battery is illustrated in Table 2.

### Implementation Example 4

The test battery was fabricated by a procedure similar to Implementation Example 2 except that the current collector obtained in Production Example 2 was used as the current collector for the negative electrode. The specification of the test battery is illustrated in Table 2.

### Comparative Example 1

The test battery was fabricated by a procedure similar to Implementation Example 1 except that the current collector obtained in Production Example 3 was used as the current collector for the negative electrode. The specification of the test battery is illustrated in Table 2.

### Comparative Example 2

The test battery was fabricated by a procedure similar to Implementation Example 2 except that the current collector obtained in Production Example 3 was used as the current collector for the negative electrode. The specification of the test battery is illustrated in Table 2.

### Comparative Example 3

The test battery was fabricated by a procedure similar to Implementation Example 1 except that the current collector obtained in Production Example 4 was used as the current collector for the negative electrode. The specification of the test battery is illustrated in Table 2.

### Comparative Example 4

The test battery was fabricated by a procedure similar to Implementation Example 2 except that the current collector obtained in Production Example 4 was used as the current collector for the negative electrode. The specification of the test battery is illustrated in Table 2.

### Reference Example 1

The test battery was fabricated by a procedure similar to Implementation Example 1 except that the current collector obtained in Production Example 5 was used as the current collector for the negative electrode. The specification of the test battery is illustrated in Table 2.

### Reference Example 2

The test battery was fabricated by a procedure similar to Implementation Example 2 except that the current collector obtained in Production Example 5 was used as the current collector for the negative electrode. The specification of the test battery is illustrated in Table 2.

### Reference Example 3

The test battery was fabricated by a procedure similar to that of Implementation Example 1 except that the current collector obtained by production example 5 was used as the current collector for the negative electrode and the pressure test on the weld point was not performed. The specification of the test battery is illustrated in Table 2. The test battery in Reference Example 3 was used as the standard for the cycle test described below.

TABLE 2

| | CURRENT COLLECTOR | | | CYCLE | CONCAVE AND |
|---|---|---|---|---|---|
| No | FOR NEGATIVE ELECTRODE | PRESSURE TEST | TENSILE TEST | PERFORMANCE | CONVEX REGION |
| IMPLEMENTATION | PRODUCTION EXAMPLE 1 | PERFORMED | PERFORMED | ◯ | YES |
| EXAMPLE 1 | | | | | |
| IMPLEMENTATION | PRODUCTION EXAMPLE 1 | NOT PERFORMED | NOT PERFORMED | ⊚ | YES |
| EXAMPLE 2 | | | | | |
| IMPLEMENTATION | PRODUCTION EXAMPLE 2 | PERFORMED | PERFORMED | ⊚ | YES |
| EXAMPLE 3 | | | | | |
| IMPLEMENTATION | PRODUCTION EXAMPLE 2 | NOT PERFORMED | PERFORMED | ⊚ | YES |
| EXAMPLE 4 | | | | | |
| COMPARATIVE | PRODUCTION EXAMPLE 3 | PERFORMED | NOT PERFORMED | X | NO |
| EXAMPLE 1 | | | | | |
| COMPARATIVE | PRODUCTION EXAMPLE 3 | NOT PERFORMED | PERFORMED | X | NO |
| EXAMPLE 2 | | | | | |
| COMPARATIVE | PRODUCTION EXAMPLE 4 | PERFORMED | NOT PERFORMED | Δ | NO |
| EXAMPLE 3 | | | | | |
| COMPARATIVE | PRODUCTION EXAMPLE 4 | NOT PERFORMED | PERFORMED | Δ | NO |
| EXAMPLE 4 | | | | | |
| REFERENCE | PRODUCTION EXAMPLE 5 | PERFORMED | NOT PERFORMED | ⊚ | NO |
| EXAMPLE 1 | | | | | |
| REFERENCE | PRODUCTION EXAMPLE 5 | NOT PERFORMED | PERFORMED | ⊚ | NO |
| EXAMPLE 2 | | | | | |
| REFERENCE | PRODUCTION EXAMPLE 5 | NOT PERFORMED | NOT PERFORMED | ⊚ | NO |
| EXAMPLE 3 | | | | | |

### (Evaluation)

### (Cycle Performance)

The cycle property of each test battery was evaluated with the condition of 4.2 V to 2.4 V by using the test battery fabricated in each of Implementation Example 1 to Implementation Example 4, Comparative Example 1 to Comparative Example 4, and Reference Examples 1 to 3. Specifically, 100 cycles of charging and discharging at a constant current were repeated and the charge capacity, discharge capacity, and voltage value during the charging and discharging were recorded. A charging time per cycle was ten hours and a discharging time per one cycle was two hours. The conditions during the charging were a temperature of 25° C., a current density of 1.53 mA/cm², and a current value of 24 mA. The conditions during the discharging were a temperature of 25° C., a current density of 7.67 mA/cm², and a current value of 120 mA.

The result of the cycle test for each test battery is illustrated in Table 2. In Table 2, a double circle indicates that, when the capacity retention rate of the test battery in Reference Example 3 after the elapse of 100 cycles is considered as the standard value, the test battery has a performance of 90% or more of the standard value. A single circle indicates that the test battery has a performance of 80% or more and less than 90% of the above-described standard value. A triangle indicates that the test battery has a performance of 70% or more and less than 80% of the above-described standard value. X indicates that the test battery has a performance of less than 70% of the above-described standard value.

### (Observation of the Weld Point of the Negative Electrode)

The weld point of the negative electrode of the test battery fabricated in each of Implementation Example 1 to Implementation Example 4, Comparative Example 1 to Comparative Example 4, and Reference Examples 1 to 3 was observed to confirm the presence or absence of the above-described concave and convex region. The confirmation result is illustrated in Table 2.

The presence or absence of the concave and convex points was confirmed according to the procedure described below. At first, a sample was cut from the negative electrode of each test battery, the sample including the weld region of the negative electrode. The size of each sample was 50 mm×50 mm and the weld region was arranged at the approximate center portion of each sample.

Then, the X-CT observation for the sample of each implementation example and each comparative example was performed. An X-ray microscope (SKYSCAN 1272 CMOS EDITION) made by BRUKER was used for the X-CT observation. In all the implementation examples, the above-described bellows shape was observed. On the other hand, in the sample of each comparative example, the above-described bellows shape was not observed. Therefore, an SEM observation for the sample of each comparative example was performed. At first, a cross section polisher (made by JEOL Ltd., product number: IB-09020 CP) was used to cut the sample of each comparative example. Each sample was cut such that the cross-section includes the approximately center portion of the weld region. Then, the cross-section was observed by SEM.

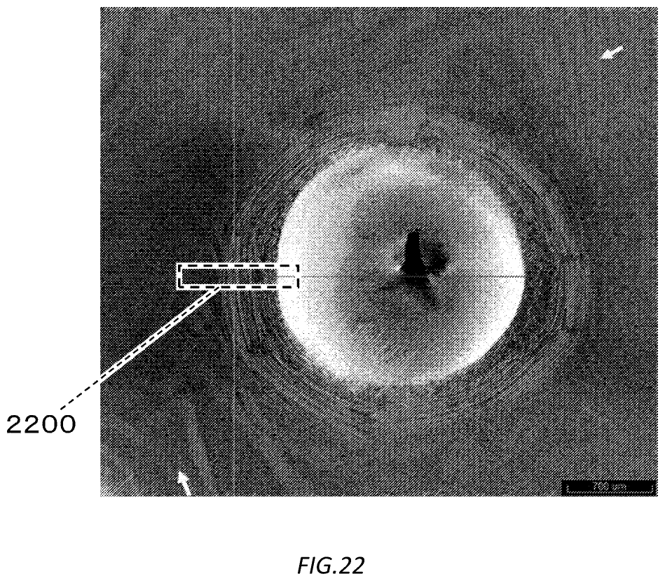

FIG. 22 illustrates the observation result from the X-CT for the welding portion of the negative electrode fabricated in Implementation Example 2. FIG. 22 is an X-CT image in the case where the sample was observed from the side of the lead and the depth of the observation plane was adjusted as appropriate. Specifically, it is an image captured such that the lead except the welded portion was not visible by observing the sample at an angle with the lead side being the front side. The region of an approximate circle in the vicinity of the center in FIG. 22 is a weld region. As illustrated in FIG. 22, according to the present implementation example, it can be seen that a plurality of wrinkles with an approximately circular or approximately polygonal shape were arranged in a concentric circular or concentric polygonal shape. For example, in the observation region 2200, a plurality of wrinkles were formed to be adjacent to the weld region.

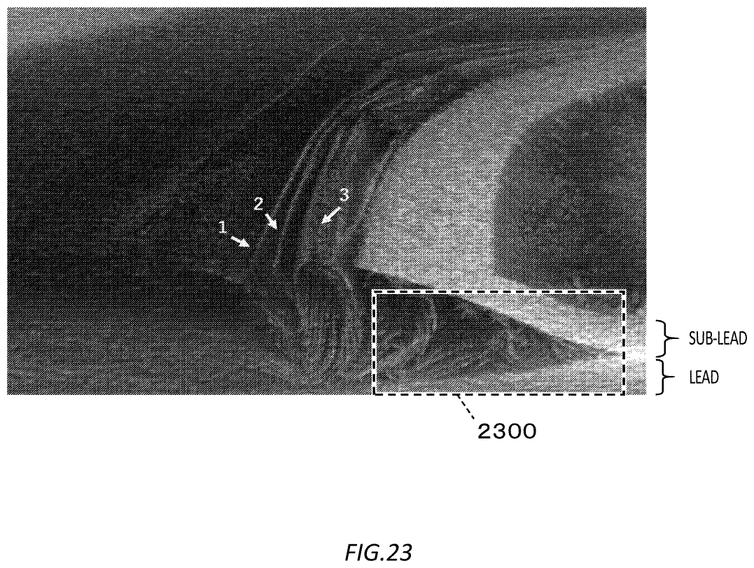

FIG. 23 illustrates the observation result from the X-CT for the cross-section of the observation region 2200 illustrated in FIG. 22. As illustrated in FIG. 23, according to the present implementation example, it can be seen that the plurality of wrinkles or bellows shapes were formed not only inside the observation region 2300 sandwiched by the lead and the sub-lead but also outside the observation region 2300. Specifically, at least three peaks are observed outside the observation region 2300.

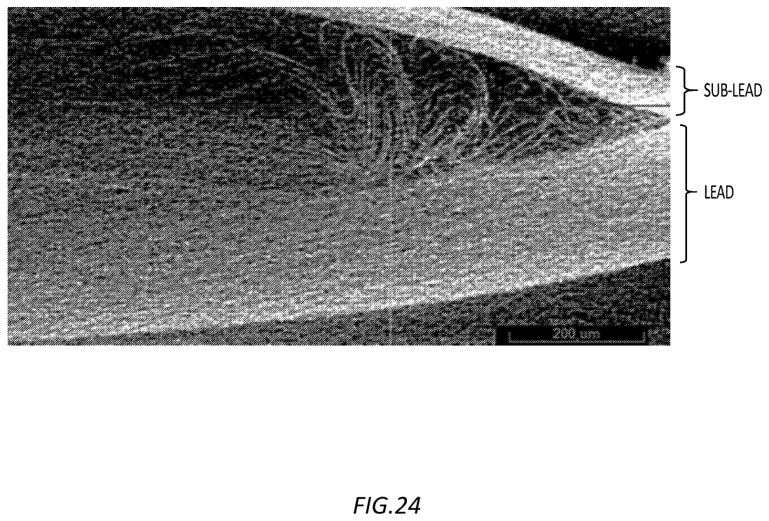

FIG. 24 illustrates the observation result from the X-CT for the observation region 2300 illustrated in FIG. 23. As illustrated in FIG. 23, according to the present implementation example, it can be seen that a number of wrinkles or bellows shapes are also formed inside the observation region 2300 sandwiched by the lead and the sub-lead.

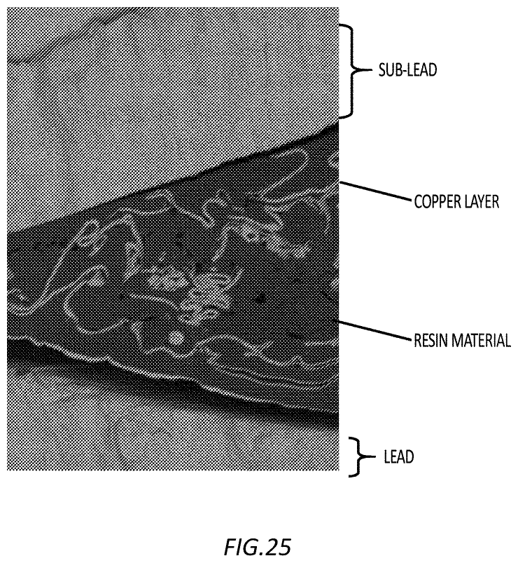

FIG. 25 illustrates the SEM image of the welding portion of the negative electrode fabricated in Comparative Example 1. FIG. 25 illustrates the cross-section of the adjacent region that is adjacent to the weld region. As illustrated in FIG. 25, according to the present comparative example, it can be seen that the resin material extruded from the weld region fractures the copper layer formed on both faces of the negative electrode current collector.

While the present invention has been described by way of the embodiments, the technical scope of the present invention is not limited to the above-described embodiments. It is apparent to persons skilled in the art that various alterations or improvements can be made to the above-described embodiments. It is also apparent from the described scope of the claims that the embodiments added with such alterations or improvements can be included the technical scope of the present invention.

It should be noted that the operations, procedures, steps, stages or the like of each process performed by an apparatus, system, program, and method shown in the scope of the claims, embodiments, or diagrams can be performed in any order as long as the order is not indicated by “prior to,” “before,” or the like and as long as the output from a previous process is not used in a later process. Even if the process flow is described by using phrases such as “first”, “then” or the like in the scope of the claims, embodiments, or diagrams, it does not necessarily mean that the process must be performed in this order.

### EXPLANATION OF REFERENCES

100 flight vehicle, 110 power storage battery, 112 power storage cell, 120 power control circuit, 130 electric motor, 140 propeller, 150 sensor, 160 controller, 212 positive electrode case, 214 negative electrode case, 216 sealant, 218 metal spring, 220 positive electrode, 222 positive electrode current collector, 224 positive electrode active material layer, 230 separator, 240 negative electrode, 242 negative electrode current collector, 244 negative electrode active material layer, 260 structure, 350 electrolyte, 400 current collector, 420 support layer, 422 first planer surface, 424 second planer surface, 426 side surface, 442 electrically conductive layer, 444 electrically conductive layer, 500 current collector, 522 through-hole, 546 electrically conductive material, 600 current collector, 620 through-hole, 622 inner wall portion, 642 electrically conductive layer, 760 stack structure, 820 positive electrode connection, 822 lead, 824 sub-lead, 840 negative electrode connection, 842 lead, 844 sub-lead, 1102 current collector, 1104 current collector, 1120 welding device, 1130 welding head, 1132 position adjustment unit, 1134 heating unit, 1136 welding unit, 1140 heating power supply, 1150 welding power supply, 1160 controller, 1520 integrated region, 1522 approximate center, 1540 region, 1600 concave and convex region, 1620 adjacent region, 1640 smooth region, 1900 concave and convex region, 2020 complex region, 2022 solid, 2200 observation region, 2300 observation region.

What is claimed is:

1. A stack comprising a plurality of sheet materials which are stacked, wherein
each of the plurality of sheet materials has:
a support layer including thermoplastic resin material; and
a first metal layer and a second metal layer formed on both faces of the support layer,
in a part of the plurality of sheet materials, a plurality of the first metal layers and a plurality of the second metal layers included in the plurality of sheet materials are integrated,
each of the plurality of first metal layers and the plurality of second metal layers includes a concave and convex region where each metal layer has a bellows-like shape or a wrinkled shape,
the stack has:
an integrated region which is a region where the plurality of first metal layers and the plurality of second metal layers are integrated by welding; and
a smooth region which is a region away from an end of the integrated region,
the smooth region is a region where an absolute value of a difference between a maximum value and a minimum value of measurement values of thickness at three points therein is 5% or less of an average value of measurement values of thickness at the three points, and
the concave and convex region is formed in an adjacent region arranged between the integrated region and the smooth region.

2. The stack according to claim 1, wherein, in the concave and convex region, each metal layer includes a plurality of peak portions and at least one trough portion arranged along an in-plane direction of each metal layer.

3. The stack according to claim 1, wherein a ratio of a volume of resin included in the integrated region to a volume of metal included in the integrated region is from 5 to 50%.

4. The stack according to claim 1, wherein a ratio of a volume of voids included in the integrated region to a volume of metal included in the integrated region is 10% or less.

5. The stack according to claim 1, wherein the plurality of sheet materials have:
a first sheet material arranged on one side of outermost sides of the plurality of sheet materials; and
a second sheet material arranged on another side of outermost sides of the plurality of sheet materials,
the stack further comprises:
a first support member which supports the first sheet material; and
a second support member which supports the second sheet material,
the first support member and the second support member include metal, and
in the part of the plurality of sheet materials, the first support member, the second support member, the plurality of first metal layers, and the plurality of second metal layers are integrated.

6. The stack according to claim 1, wherein each of the plurality of sheet material has, in a vicinity of the integrated region, a region where a plurality of through-holes extending through each sheet material are formed.

7. The stack according to claim 1, further comprising an electrically conductive member which electrically connects a first metal layer and a second metal layer arranged on each of the plurality of sheet materials.

8. The stack according to claim 1, wherein a maximum value of thickness of the adjacent region is from 1.1 to 1.3 times of an average value of measurement values of thickness at the three points in the smooth region.

9. The stack according to claim 8, wherein each of the plurality of sheet materials has, in a vicinity of the integrated region, a region where a plurality of through-holes extending through each sheet material are formed, and
a ratio of a volume of resin included in the integrated region to a volume of metal included in the integrated region is from 5 to 50%.

10. The stack according to claim 1, wherein a shape of the concave and convex region in a face approximately perpendicular to a stack direction of a plurality of sheet materials is an approximately concentric circular or approximately concentric polygonal shape.

11. The stack according to claim 1, wherein a number of peaks arranged in the concave and convex region is six or more.

12. The stack according to claim 2, wherein a ratio of a volume of resin included in the integrated region to a volume of metal included in the integrated region is from 5 to 50%.

13. The stack according to claim 2, wherein a ratio of a volume of voids included in the integrated region to a volume of metal included in the integrated region is 10% or less.

14. The stack according to claim 2, wherein the plurality of sheet materials have:
a first sheet material arranged on one side of outermost sides of the plurality of sheet materials; and
a second sheet material arranged on another side of outermost sides of the plurality of sheet materials,
the stack further comprises:
a first support member which supports the first sheet material; and
a second support member which supports the second sheet material,
the first support member and the second support member include metal, and
in the part of the plurality of sheet materials, the first support member, the second support member, the plurality of first metal layers, and the plurality of second metal layers are integrated.

15. The stack according to claim 2, wherein each of the plurality of sheet material has, in a vicinity of the integrated region, a region where a plurality of through-holes extending through each sheet material are formed.

16. The stack according to claim 2, further comprising an electrically conductive member which electrically connects a first metal layer and a second metal layer arranged on each of the plurality of sheet materials.

17. An electrode structure comprising:
a first electrode and a second electrode;
a third electrode; and
a first separator and a second separator,
wherein the first electrode, the first separator, the third electrode, the second separator, and the second electrode are stacked in this sequence,
each of the first electrode and the second electrode has:
a current collector; and
an active material layer arranged on at least one face of the current collector,
the current collector includes:
an support layer including a thermoplastic resin material; and
a first metal layer and a second metal layer formed on both faces of the support layer,
in a vicinity of ends of the first electrode and the second electrode, (i) the first electrode and the second electrode are stacked, and (ii) the first metal layer and the second metal layer of the first electrode, and the first metal layer and the second metal layer of the second electrode are integrated,
each of the first metal layer and the second metal layer of the first electrode, and the first metal layer and the second metal layer of the second electrode includes a concave and convex region where each metal layer has a bellows-like shape or a wrinkled shape,
the first electrode and the second electrode which are stacked have:
an integrated region which is a region where the first metal layer and the second metal layer of the first electrode, and the first metal layer and the second metal layer of the second electrode are integrated by welding; and
a smooth region which is a region away from an end of the integrated region,
the smooth region is a region where an absolute value of a difference between a maximum value and a minimum value of measurement values of thickness at three points therein is 5% or less of an average value of measurement values of thickness at the three points, and
the concave and convex region is formed in an adjacent region arranged between the integrated region and the smooth region.

18. The electrode structure according to claim 17, further comprising:
a fourth electrode; and
a third separator,
wherein the first electrode, the first separator, the third electrode, the second separator, the second electrode, the third separator, and the fourth electrode are stacked in this sequence,
each of the first electrode, the second electrode, the third electrode, and the fourth electrode has:
the current collector; and
the active material layer,
in a vicinity of ends of the third electrode and the fourth electrode, (i) the third electrode and the fourth electrode are stacked and (ii) the first metal layer and the second metal layer of the third electrode, and the first metal layer and the second metal layer of the fourth electrode are integrated,
each of the first metal layer and the second metal layer of the third electrode, and the first metal layer and the second metal layer of the fourth electrode includes a second concave and convex region where each metal layer has a bellows-like shape or a wrinkled shape,
the third electrode and the fourth electrode which are stacked has:
a second integrated region which is a region where the first metal layer and the second metal layer of the third electrode, and the first metal layer and the second metal layer of the fourth electrode are integrated by welding; and
a second smooth region which is a region away from ends of the second integrated region,
the second smooth region is a region where an absolute value of a difference between a maximum value and a minimum value of measurement values of thickness at three points therein is 5% or less of an average value of measurement values of thickness at the three points, and
the second concave and convex region is formed in a second adjacent region arranged between the second integrated region and the second smooth region.

19. A battery comprising:
the electrode structure according to claim 17; and
a housing that accommodates the electrode structure.

20. A flight vehicle comprising:
the battery according to claim 19; and
a propulsive force generator that generates propulsive force using electrical energy accumulated in the battery.
